(19) United States
(12) Patent Application Publication
(10) Pub. No.: US 2016/0313661 A1
(43) Pub. Date: Oct. 27, 2016

(54) TONER FOR DEVELOPING ELECTROSTATICALLY CHARGED IMAGES

(71) Applicant: Konica Minolta, Inc., Tokyo (JP)

(72) Inventors: Kouji SEKIGUCHI, Tokyo (JP); Shiro HIRANO, Tokyo (JP); Naoya TONEGAWA, Sagamihara-shi (JP); Masaharu MATSUBARA, Tokyo (JP); Atsushi IIOKA, Tokyo (JP)

(21) Appl. No.: 15/087,210

(22) Filed: Mar. 31, 2016

(30) Foreign Application Priority Data
Apr. 22, 2015 (JP) 2015-087222

(51) Int. Cl. G03G 9/097; G03G 9/087

(52) U.S. Cl. CPC G03G 9/09733; G03G 9/08711

(57) ABSTRACT

A particulate toner for developing electrostatically charged image includes a binder resin, a colorant, a mold release agent and a plasticizer. The binder resin comprises a styrene-acrylic resin. A relationship represented by Expression Ac<Aw is satisfied. Aw represents the average aspect ratio of domains of the mold release agent in a cross section of the particulate toner. Ac represents the average aspect ratio of domains of the plasticizer.

### BACKGROUND OF THE INVENTION

1. Field of the Invention

The present invention relates to toners for developing electrostatically charged images. The present invention more specifically relates to toners for developing electrostatically charged images, the toners having excellent low-temperature fixing characteristics, heat resistance, post-fixing separability, and durability.

2. Description of Related Art

Toners for developing electrostatically charged images (hereinafter, also simply referred to as “toners”) having low fixing temperatures have been required to meet electrophotographic imaging apparatuses having higher print speed and further reduced energy consumption for a reduction in environmental loads. In such toners, their fixing temperatures should be reduced through a reduction in melting temperatures or melt viscosities of binder resins contained in the toners. Several documents propose toners having low-temperature fixing characteristics improved through addition of crystalline resins, such as crystalline polyester resins, as plasticizers (fixing aids).

For example, JP 2013-190667A discloses a toner comprising a particulate mold release agent and a plasticizer, and techniques of enhancing the low-temperature fixing characteristics and achieving high gloss of a toner through control of the average particle size of the particulate mold release agent contained in the toner and the area ratio of the particulate mold release agent around the inner surface of the toner.

JP 2013-137420A discloses a technique of preparing a toner having compatibility between low-temperature fixing characteristics and heat resistance through control of the endothermic peak temperatures determined by differential calorimetric analysis of a mold release agent and a particulate plasticizer (crystalline polyester resin) in a toner and the flow-start temperature of the toner, and control of the average diameter of the particulate crystalline polyester resin dispersed.

It is important, however, that toners have not only the compatibility between the low-temperature fixing characteristics and heat-resistant storage characteristics, but also post-fixing separability and durability. Consequently, a toner having all of these performances has been required.

### SUMMARY OF THE INVENTION

The present invention has been made in consideration of such problems and circumstances. An object of the present invention is to provide a toner for developing electrostatically charged images having excellent low-temperature fixing characteristics, heat resistance, post-fixing separability, and durability.

The present inventor, who has conducted extensive research to solve the problems, has found that a toner having high post-fixing separability, heat resistance, and durability can be produced while maintaining low-temperature fixing characteristics through control of a mold release agent and a plasticizer contained in the toner such that the domain of the mold release agent has a larger aspect ratio than that of the plasticizer, and has completed the present invention.

In order to realize the above object, according to a first aspect of the present invention, there is provided a particulate toner for developing electrostatically charged image, including:

a binder resin,

a colorant,

a mold release agent, and

a plasticizer,

wherein the binder resin comprises a styrene-acrylic resin, and

a relationship represented by Expression (1) is satisfied:

Ac<Aw (1)

where Aw represents an average aspect ratio of domains of the mold release agent, and Ac represents an average aspect ratio of domains of the plasticizer in a cross section of the particulate toner.

Preferably, the binder resin comprises 30 mass % or more styrene-acrylic resin.

Preferably, relationships represented by Expressions (2) and (3) are satisfied:

1.5≦Aw≦6.0 (2)

1.0≦Ac≦3.0 (3)

where Aw represents the average aspect ratio of the domains of the mold release agent, and Ac represents the average aspect ratio of the domains of the plasticizer in the cross section of the particulate toner.

Preferably, the mold release agent comprises a microcrystalline wax.

Preferably, the plasticizer comprises a crystalline polyester resin.

Preferably, the plasticizer comprises a hybrid resin comprising a crystalline polyester resin unit and an amorphous resin unit bonded to each other.

Preferably, the amorphous resin unit comprises a styrene-acrylic resin unit, and a content of the styrene-acrylic resin unit is 20 mass % or less of that of the hybrid resin.

Preferably, a content of the mold release agent and a content of the plasticizer are each within a range of 5 to 20 mass % of a total amount of the particulate toner excluding the colorant.

Preferably, the domains of the mold release agent and the domains of the plasticizer are independently present.

Although the mechanism or the action attaining the advantageous effects of the present invention has not been completely clarified, the present inventor infers the following mechanism or action.

The mold release agent contained in the toner can demonstrate the mold release effect if it is efficiently exposed from the inside to the surface of the particulate toner during a thermal fixing process. As a result, post-fixing separability can be ensured without sacrificing low-temperature fixing characteristics. In contrast, reduced exposure of the mold release agent to the surface of the particulate toner at normal temperature can prevent reductions in heat resistance and durability caused by filming of a photoreceptor or a carrier spent by the toner.

The particulate toner according to the present invention contains the mold release agent and the plasticizer, and the average aspect ratio of the domains of the mold release agent in a cross section of the particulate toner is larger than that of the plasticizer.

The particulate toner according to the present invention contains domains of the plasticizer having a smaller aspect ratio dispersed therein and thus has uniform plasticizing characteristics by the plasticizer during a thermal fixing process. The toner also has high low-temperature fixing characteristics because of efficiently promoted exposure of the mold release agent to the surface of the toner. An increase in the aspect ratios of the domains of the mold release agent results in little exposition of the mold release agent to the surface of the particulate toner at normal temperature and little agglomeration of the mold release agent. Accordingly, the toner also has high heat resistance and durability.

For these reasons, a toner having high post-fixing separability, heat resistance, and durability can be achieved without sacrificing the low-temperature fixing characteristics of the toner.

### BRIEF DESCRIPTION OF THE DRAWINGS

The present invention will become more fully understood from the detailed description given hereinbelow and the appended drawings which are given byway of illustration only, and thus are not intended as a definition of the limits of the present invention, and wherein:

FIG. 1 is a schematic view illustrating of a cross section of a particulate toner.

### DETAILED DESCRIPTION OF THE PREFERRED EMBODIMENT

A particulate toner of the present invention for developing electrostatically charged image comprises a binder resin, a colorant, a mold release agent, and a plasticizer. The binder resin comprises a styrene-acrylic resin. A relationship represented by Expression (1) is satisfied. Aw represents the average aspect ratio of domains of the mold release agent, and Ac represents the average aspect ratio of domains of the plasticizer in a cross section of the particulate toner.

In a preferable embodiment according to the present invention, the binder resin contains 30 mass % or more styrene-acrylic resin to demonstrate the advantageous effects of the present invention. The styrene-acrylic resin has high elasticity at high temperatures, and enhances post-fixing separability and high-temperature offset resistance.

In a preferable embodiment according to the present invention, relationships represented by Expressions (2) and (3) are satisfied to demonstrate the advantageous effects of the present invention. Aw represents the average aspect ratio of the domains of the mold release agent, and Ac represents the average aspect ratio of the domains of the plasticizer in the cross section of the particulate toner.

An enhancement in post-fixing separability and high-temperature offset resistance results in a sufficient mold releasing effect of the mold release agent during a thermal fixing process. In addition, the uniform plasticizing effect of the plasticizer can promote the bleed-out of the mold release agent during a thermal fixing process.

In a preferable embodiment according to the present invention, the mold release agent comprises a microcrystalline wax. The microcrystalline wax contained in the mold release agent facilitates growth of the domains of the mold release agent having large aspect ratios inside the toner so that the shapes of the domains satisfy the relationship represented by Expression (1) or (2).

In a preferable embodiment according to the present invention, the plasticizer contained in the toner is a crystalline polyester resin to enhance low-temperature fixing characteristics and post-fixing separability. The crystalline polyester resin has ester bonds, and readily adsorbs moisture. As a result, electric discharge from the toner can be further promoted to more significantly prevent adhesion between sheets having thermally fixed toner images and fixing members.

In a preferable embodiment according to the present invention, the plasticizer comprises a hybrid resin comprising a crystalline polyester resin unit and an amorphous resin unit bonded to each other. The hybrid resin contained in the plasticizer can enhance the affinity of the plasticizer with the binder resin, and can more uniformly and finely control the size of the dispersed domains of the plasticizer to enhance low-temperature fixing characteristics. The hybrid resin contained in the plasticizer is also preferred because the domains of the plasticizer readily have shapes satisfying the relationship represented by Expression (1) or (3).

In a preferable embodiment according to the present invention, the amorphous resin unit comprises a styrene-acrylic resin unit, and a content of the styrene-acrylic resin unit is 20 mass % or less of that of the hybrid resin. This results in formation of more homogeneous domains of the plasticizer while the crystalline polyester resin has sufficient crystallinity.

In a preferable embodiment according to the present invention, a content of the mold release agent and a content of the plasticizer are each within a range of 5 to 20 mass % of a total amount of the particulate toner excluding the colorant. A plasticizer contained within the range of 5 to 20 mass % can enhance the sharp-melt characteristics of the binder resin to enhance low-temperature fixing characteristics, and can prevent a reduction in heat resistance of the toner. A mold release agent contained within the range of 5 to 20 mass % can enhance post-fixing separability, and can prevent a reduction in heat resistance and durability of the toner, which is caused by addition of the mold release agent.

In a preferable embodiment according to the present invention, the domains of the mold release agent and the domains of the plasticizer are independently present to demonstrate the advantageous effects of the present invention. As a result, the characteristics of the individual domains can be effectively demonstrated.

The present invention, components thereof, and embodiments and aspects for implementing the present invention will now be described in detail. Throughout the specification, the term “to” between numeric values indicates that the numeric values before and after the term are inclusive as the lower limit and the upper limit, respectively.

### [Toner for Developing Electrostatically Charged Images]

The “toner for developing electrostatically charged images (also simply referred to as “toner”)” according to the present invention refers to a collection of toner particles.

### <<Particulate Toner>>

The particulate toner at least comprises a binder resin, a colorant, a mold release agent, and a plasticizer. The binder resin contains a styrene-acrylic resin.

The particulate toner may further contain optional components, such as a charge control agent, and may contain so-called external additives, such as fluidizing agents and cleaning aids.

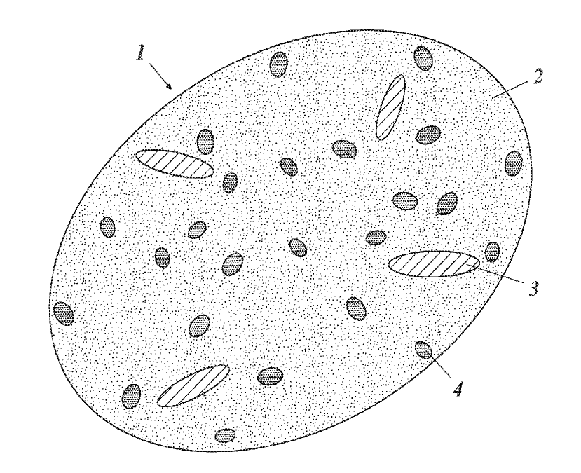

FIG. 1 illustrates the structure of the particulate toner. In the cross-sectional schematic view, the particulate toner 1 is composed of a matrix 2 of a binder resin (binder), and at least domains 3 of the mold release agent and domains 4 of the plasticizer dispersed in the matrix 2.

Throughout the specification, the “matrix” functions as a medium (base) containing and retaining domains, and the “domains” are present in the matrix as independent minute regions. The matrix and the domains are not miscible with each other, that is, are phase-separated (formation of a domain-matrix structure). Such a structure enables the matrix and the domains to demonstrate their own characteristics. It is also preferred that the domains of the mold release agent and the domains of the plasticizer be independently present to effectively demonstrate the characteristics of the respective domains. These domains may be in contact with each other, or may be separately or independently present in the matrix. It is preferred that the domains be separately or independently present in the matrix.

The domains of the mold release agent and the domains of the plasticizer contained in the particulate toner according to the present invention satisfy the relationship represented by Expression (1) in observation of a cross section of the particulate toner:

Ac<Aw (1)

where Aw represents the average aspect ratio of the domains of the mold release agent and Ac represents the average aspect ratio of the domains of the plasticizer in the cross section of the particulate toner.

The particulate toner can have high post-fixing separability, heat resistance, and durability while maintaining low-temperature fixing characteristics through dispersion of the domains of the plasticizer and those of the mold release agent having average aspect ratios satisfying the relationship represented by Expression (1) in the particulate toner.

The “aspect ratio” of a domain in the present invention can be determined from the shape of the domain observed in the cross section of a particulate toner and Expression (A1):

Aspect ratio=(long axis diameter of domain)/(short axis diameter of domain)

Throughout the specification, the “average aspect ratio” indicates the average of the aspect ratios of domains. In detail, the average aspect ratio in the present invention is determined as follows: Toner particles are selected at random, and 100 domains present in any cross section of each toner particle are selected. The aspect ratios of the 100 domains are determined, and the average thereof is calculated as the average aspect ratio of the domains.

The average aspect ratio Aw of the domains of the mold release agent and the average aspect ratio Ac of the domains of the plasticizer preferably satisfy the relationships represented by Expressions (2) and (3), respectively:

1.5≦Aw≦6.0 (2)

1.0≦Ac≦3.0 (3)

Control of the respective domains to have such average aspect ratios results in a mold release agent having a sufficient mold release effect during a thermal fixing process, and can promote bleed-out of the mold release agent caused by the uniform plasticizing effect of the plasticizer during a thermal fixing process.

### (Calculation of Average Aspect Ratio)

The average aspect ratios of the domains of the mold release agent and the domains of the plasticizer contained in the particulate toner are calculated according to the following procedure, for example.

### (1. Preparation of Section of Particulate Toner)

The particulate toner is stained with vapor of ruthenium tetraoxide (RuO₄) from a vacuum electron staining apparatus VSC1R1 (made by Filgen, Inc.) at room temperature (24 to 25° C.) and Concentration level 3 (300 Pa) for 10 minutes. The stained sample is dispersed in a photocurable resin “D-800” (made by JEOL, Ltd.), and the resin is cured with UV light to form a block. The block is sliced with a microtome having a diamond knife to prepare an ultra-thin sample having a thickness of 60 to 100 nm.

### (2. Observation of Cross Section of Particulate Toner)

The cross section of the particulate toner in the ultra-thin sample stained with ruthenium tetraoxide (RuO₄) is observed with a transmission electron microscope “JEM-2000FX” (made by JEOL, Ltd.) at an accelerating voltage of 80 kV and a magnification of ×50000 (bright-field image).

### (3. Calculation of Average Aspect Ratio)

The cross section of the particulate toner is photographed, and the photographed image is input with a scanner. The photograph image is then analyzed with an image processing analyzer “LUZEX AP” (made by NIRECO CORPORATION). Among the domains observed in the particulate toner in the image, the whitest portions are defined as the domains of the mold release agent, and whiter portions defined as the domains of the plasticizer. The long axis lengths and short axis lengths of the domains are measured.

In the measurement of the “long axis length”, each domain is sandwiched between sets of two parallel lines contacting with the outline of the domain. Among the sets of two parallel lines, the set of two parallel lines having the largest interval is determined. A line segment composed of a straight line connecting two tangent points of the two parallel lines and the outline of the domain is defined as the long axis. The length of the line segment is measured as the “long axis length”.

In the measurement of the “short axis length”, a perpendicular passing through the center of the long axis is drawn orthogonal to the outline of the domain on the same plane of the outline of the domain. A line segment composed of a straight line connecting two intersection points of the perpendicular and the outline is defined as the short axis. The length of the line segment is measured as the “short axis length”.

The aspect ratio is calculated from the long axis length, the short axis length, and Expression (A1):

Aspect ratio=(long axis diameter of domain)/(short axis diameter of domain)

The average aspect ratio of a domain is determined as follows, for example: Toner particles are selected at random, and 100 domains present in any cross section of each toner particle are selected. The aspect ratios of these 100 domains are determined, and the average thereof is calculated as the average aspect ratio of the domains.

### <Binder Resin>

A preferred binder resin is a thermoplastic resin. Any binder resin usually contained in the toner can be used. Specific examples of such a binder resin include styrene resins, acrylic resins, such as alkyl acrylate and alkyl methacrylate, styrene-acrylic resins, polyester resins, silicone resins, olefin resins, amide resins, and epoxy resins. These resins may be used alone or in combination.

A particularly preferred binder resin is a styrene-acrylic resin prepared through polymerization of a styrene monomer and an acrylic monomer. The styrene-acrylic resin has high elasticity at high temperatures, and enhances post-fixing separability and high-temperature offset resistance.

The binder resin preferably contains 30 mass % or more styrene-acrylic resin to demonstrate the advantageous effects described above.

The styrene-acrylic resin preferably has a weight average molecular weight (Mw) within the range of 25000 to 60000 and a number average molecular weight (Mn) within the range of 8000 to 15000 to ensure the low-temperature fixing characteristics of the toner and the stability of the gloss level.

Polymerizable monomers used in the styrene-acrylic resin are aromatic vinyl monomers and (meth)acrylate ester monomers preferably having ethylenically unsaturated bonds and allowing radical polymerization.

Examples of the styrene monomer include styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, 3,4-dichlorostyrene, and derivatives thereof. These aromatic vinyl monomers may be used alone in combination.

Concerning the acrylic monomer, examples of the acrylate ester monomer include methyl acrylate, ethyl acrylate, butyl acrylate, 2-ethylhexyl acrylate, cyclohexyl acrylate, and phenyl acrylate. Examples of the methacrylate ester monomer include methyl methacrylate, ethyl methacrylate, butyl methacrylate, hexyl methacrylate, 2-ethylhexyl methacrylate, β-hydroxyethyl acrylate, γ-aminopropyl acrylate, stearyl methacrylate, dimethylaminoethyl methacrylate, and diethylaminoethyl methacrylate. These (meth)acrylate ester monomers may be used alone or in combination. Among these monomers, styrene monomers can be preferably used in combination with at least one of acrylate ester monomers and methacrylate ester monomers.

A third vinyl monomer can be used as the polymerizable monomer. Examples of the third vinyl monomer include acid monomers, such as acrylic acid, methacrylic acid, maleic anhydride, and vinyl acetate, acrylamides, methacrylamides, acrylonitriles, ethylene, propylene, butylene, vinyl chloride, N-vinylpyrrolidone, and butadiene.

A polyfunctional vinyl monomer can also be used as the polymerizable monomer. Examples of the polyfunctional vinyl monomer include diacrylates, such as ethylene glycol, propylene glycol, butylene glycol, and hexylene glycol; divinylbenzene; and dimethacrylates and trimethacrylates of alcohols having three or more hydroxy groups, such as pentaerythritol and trimethylolpropane. The content of the polyfunctional vinyl monomer to be copolymerized is within the range of usually 0.001 to 5 mass %, preferably 0.003 to 2 mass %, more preferably 0.01 to 1 mass % of the total amount of the polymerizable monomer. Use of the polyfunctional vinyl monomer generates a gel component insoluble in tetrahydrofuran. The content of the gel component in the total amount of the polymerized product is usually 40 mass % or less, preferably 20 mass % or less.

The binder resin is preferably prepared through emulsion polymerization. In emulsion polymerization, a polymerizable monomer, such as styrene or acrylate ester, is dispersed in an aqueous medium, and is polymerized to prepare a binder resin. A surfactant is preferably used to disperse the polymerizable monomer in an aqueous medium. Polymerization can be performed using a polymerization initiator and a chain transfer agent.

### (Polymerization Initiator)

The polymerization initiator used in preparation of the binder resin through polymerization can be any known polymerization initiator. Specific examples thereof include peroxides, such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, tert-hydroperoxide pertriphenylacetate, tert-butyl performate, tert-butyl peracetate, tert-butyl perbenzoate, tert-butyl perphenylacetate, tert-butyl permethoxyacetate, and tert-butyl per-N-(3-toluyl)palmitate; and azo compounds, such as 2,2′-azobis(2-amidinopropane) dihydrochloride, 2,2′-azobis-(2-amidinopropane) nitrate, 1,1′-azobis(sodium 1-methylbutyronitrile-3-sulfonate), 4,4′-azobis-4-cyanovaleric acid, and poly(tetraethyleneglycol-2,2′-azobisisobutyrate). Although the amount of the polymerization initiator to be added varies according to the desired molecular weight and the desired molecular weight distribution of the target polymer, the polymerization initiator is preferably added in an amount of 0.1 to 5.0 mass % of the polymerizable monomer.

### (Chain Transfer Agent)

A chain transfer agent is preferably added together with the polymerizable monomer during preparation of the binder resin. Addition of the chain transfer agent can control the molecular weight of the polymer. Any common chain transfer agent can be used in the polymerization process of the aromatic vinyl monomer and the (meth)acrylate ester monomer listed above to control the molecular weight of the styrene-acrylic polymerizable monomer. Examples thereof include alkyl mercaptans and mercapto fatty acid esters.

Although the amount of chain transfer agent to be added varies according to the desired molecular weight and the desired molecular weight distribution of the target polymer, the chain transfer agent is preferably added in an amount within the range of 0.1 to 5.0 mass % of the polymerizable monomer.

### (Surfactant)

In emulsion polymerization of the polymerizable monomer dispersed in an aqueous medium to prepare a binder resin, a dispersion stabilizer is usually added to prevent aggregation of liquid droplets containing the polymerizable monomer dispersed in the aqueous medium. Known surfactants can be used as the dispersion stabilizer, and can be selected from cationic surfactants, anionic surfactants, and nonionic surfactants. These surfactants may be used in combination. The dispersion stabilizer can also be used for dispersions of colorants or offsetting inhibitors.

Specific examples of the cationic surfactants include dodecylammonium bromide, dodecyltrimethylammonium bromide, dodecylpyridinium chloride, dodecylpyridinium bromide, and hexadecyltrimethylammonium bromide.

Specific examples of the nonionic surfactants include dodecyl polyoxyethylene ether, hexadecyl polyoxyethylene ether, nonylphenyl polyoxyethylene ether, lauryl polyoxyethylene ether, sorbitan monooleate polyoxyethylene ether, styrylphenyl polyoxyethylene ether, and monodecanoyl sucrose.

Specific examples of the anionic surfactants include aliphatic soaps, such as sodium stearate and sodium laurate, sodium lauryl sulfate, sodium dodecylbenzenesulfonate, and sodium polyoxyethylene(2) lauryl ether sulfate. These surfactants can be used alone or in combination when necessary.

### <Plasticizer>

Throughout the specification, the plasticizer refers to a resin having a clear endothermic peak to enhance the sharp-melt characteristics of the binder resin in the particulate toner containing the domains of the plasticizer.

Throughout the specification, the term “clear endothermic peak” specifically indicates that a resin has a half width of an endothermic peak of 15° C. or less determined by differential scanning calorimetry (DSC) at a heating rate of 10° C./min.

Any plasticizer which can enhance the sharp-melt characteristics of the binder resin as described above can be used in the present invention. In detail, any resin having a clear endothermic peak, such as crystalline polyester, crystalline polyurethane, crystalline polyurea, crystalline polyamide, and crystalline polyether resins, can be expected to enhance the sharp-melt characteristics of the particulate toner.

A particularly preferred plasticizer is a crystalline polyester resin to enhance low-temperature fixing characteristics and post-fixing separability. The crystalline polyester resin is also preferred because the resin has ester bonds, and readily adsorbs moisture. As a result, electric discharge from the toner can be further promoted to more significantly prevent adhesion between sheets having thermally fixed toner images and fixing members.

The content of the plasticizer is preferably within the range of 5 to 20 mass % of the total amount of the particulate toner excluding the colorant. A content of the plasticizer within this range leads to enhanced sharp-melt characteristics of the binder resin and thus enhanced low-temperature fixing characteristics without a reduction in heat resistance caused by addition of the plasticizer.

The plasticizer has any average particle size. For example, the plasticizer preferably has a volume median particle size of 1 μm or less.

A plasticizer composed of a crystalline polyester resin or a hybrid crystalline polyester resin (hybrid resin) will now be described as an example of a particularly preferred embodiment.

### (Crystalline Polyester Resin)

Throughout the specification, the crystalline polyester resin refers to a known resin having a clear endothermic peak prepared through polycondensation reaction of a di- or higher valent carboxylic acid (polyvalent carboxylic acid) and a di- or higher hydric alcohol (polyhydric alcohol).

The polyvalent carboxylic acid has two or more carboxy groups in the molecule.

Specific examples of the polyvalent carboxylic acid include saturated aliphatic dicarboxylic acids, such as oxalic acid, malonic acid, succinic acid, adipic acid, sebacic acid, azelaic acid, and n-dodecylsuccinic acid; alicyclic dicarboxylic acids, such as cyclohexanedicarboxylic acid; aromatic dicarboxylic acids, such as phthalic acid, isophthalic acid, and terephthalic acid; polyvalent carboxylic acids having three or higher valencies, such as trimellitic acid and pyromellitic acid; and anhydrides of these carboxylic acid compounds or alkyl esters thereof having 1 to 3 carbon atoms.

These compounds may be used alone or in combination.

The polyhydric alcohol has two or more hydroxyl groups in the molecule.

Specific examples thereof include aliphatic diols, such as 1,2-propanediol, 1,3-propanediol, 1,4-butanediol, 1,5-pentanediol, 1,6-hexanediol, 1,7-heptanediol, 1,8-octanediol, neopentyl glycol, and 1,4-butenediol; and polyhydric alcohols having three or more hydroxyl groups, such as glycerol, pentaerythritol, trimethylolpropane, and sorbitol.

These polyhydric alcohols may be used alone or in combination.

The crystalline polyester resin has a melting point within the range of preferably 60 to 90° C., more preferably 70 to 85° C. to provide a toner having sufficient low-temperature fixing characteristics. The melting point of the crystalline polyester resin can be controlled by the resin composition.

The melting point of the crystalline polyester resin indicates the temperature at the peak of an endothermic curve of the resin, which is determined through differential scanning calorimetric (DSC) analysis with Diamond DSC (made by PerkinElmer Inc.).

Specifically, a sample (crystalline polyester resin) (1.0 mg) is sealed in an aluminum pan (KIT NO. B0143013), and is set on a sample holder of Diamond DSC. The temperature of the sample is controlled from 0 to 200° C. through a series of operation of first heating, cooling, and second heating at a heating rate of 10° C./min and a cooling rate of 10° C./min. The data on the second heating is analyzed to determine the melting point of the sample.

The molecular weight of the crystalline polyester resin preferably ranges from 1000 to 15000 in terms of the number average molecular weight (Mn) in view of the low-temperature fixing characteristics of the toner and the stability of the gloss level.

The number average molecular weight (Mn) is determined by gel permeation chromatography (GPC) according to the following procedure.

GPC is performed with HLC-8120 GPC (made by Tosoh Corporation) provided with a TSKguard column and three TSKgelSuperHZ-M columns (made by Tosoh Corporation). While the column temperature is kept at 40° C., a carrier solvent tetrahydrofuran (THF) is fed at a flow rate of 0.2 ml/min. A sample (resin) is dissolved in tetrahydrofuran with an ultrasonic disperser at room temperature for five minutes such that the sample content is 1 mg/ml, and is filtered through a membrane filter having a pore size of 0.2 μm to prepare a sample solution.

The sample solution (10 μL) and the carrier solvent are injected into the gel permeation chromatograph, and the level of components in the sample solution is detected with a refractive index detector (RI detector). The molecular weight distribution of the sample is then calculated from the calibration curve produced with monodispersed standard polystyrene particles.

The calibration curve is produced with ten standard polystyrenes.

### (Hybrid Resin)

Throughout the specification, the hybrid resin (hybrid crystalline polyester resin) refers to a resin composed of crystalline polyester resin units and amorphous resin units which are chemically bonded to each other. Use of the hybrid resin as the plasticizer can enhance the affinity of the plasticizer with the binder resin, and can more uniformly and finely control the size of the dispersed domains of the plasticizer, resulting in an enhancement in low-temperature fixing characteristics.

The crystalline polyester resin unit refers to a chain forming the crystalline polyester resin. The amorphous resin unit refers to a chain forming an amorphous resin (resin which cannot have a crystalline structure).

The weight average molecular weight (Mw) of the hybrid resin is preferably within the range of 5000 to 100000, more preferably 7000 to 50000, particularly preferably 8000 to 40000 to ensure compatibility between sufficient low-temperature fixing characteristics and excellent long-term storage stability.

A hybrid resin having a weight average molecular weight (Mw) of 100000 or less results in a toner having sufficient low-temperature fixing characteristics. A hybrid resin having a weight average molecular weight (Mw) of 5000 or more can prevent excess miscibility between the hybrid resin and the amorphous resin during storage of the toner, leading to effectively reduced image defects caused by fused toner particles.

### [Crystalline Polyester Resin Unit in Hybrid Resin]

The crystalline polyester resin unit indicates a portion derived from a known polyester resin prepared through a polycondensation reaction of a di- or higher carboxylic acid (polyvalent carboxylic acid) with a di- or higher hydric alcohol (polyhydric alcohol), and having the clear endothermic peak in a curve obtained by differential scanning calorimetry of the toner rather than exhibiting a step-wise endothermic change.

Any crystalline polyester resin unit defined above can be used.

For example, resins having a structure composed of the main chain of the crystalline polyester resin unit copolymerized with another component and resins having a structure composed of the crystalline polyester resin unit copolymerized with a main chain of another component correspond to the hybrid resin having the crystalline polyester resin unit according to the present invention if the toners containing these resins have clear endothermic peaks.

The polyvalent carboxylic acid component and the polyhydric alcohol component each have preferably the valence of 2 to 3, particularly preferably the valence of 2. A particularly preferred embodiment in which the respective valences of the dicarboxylic acid component and the diol component are 2 will be described.

A dicarboxylic acid component preferably used is an aliphatic dicarboxylic acid. An aromatic dicarboxylic acid may also be used in combination. A linear aliphatic dicarboxylic acid can be preferably used. The linear aliphatic dicarboxylic acid advantageously enhances the crystallinity of the crystalline polyester resin unit. These dicarboxylic acid components may be used alone or in combination.

Examples of the aliphatic dicarboxylic acid include oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic acid (dodecanedioic acid), 1,13-tridecanedicarboxylic acid, 1,14-tetradecanedicarboxylic acid, 1,16-hexadecanedicarboxylic acid, and 1,18-octadecane dicarboxylic acid. Lower alkyl esters and acid anhydrides thereof may also be used.

Among these aliphatic dicarboxylic acids, preferred are aliphatic dicarboxylic acids having 6 to 12 carbon atoms to attain the advantageous effects of the present invention described above.

Examples of the aromatic dicarboxylic acid usable in combination with the aliphatic dicarboxylic acid include terephthalic acid, isophthalic acid, orthophthalic acid, t-butylisophthalic acid, 2,6-naphthalenedicarboxylic acid, and 4,4′-biphenyldicarboxylic acid. Among these aromatic dicarboxylic acids, preferably used are terephthalic acid, isophthalic acid, and t-butylisophthalic acid, which are readily available and emulsifiable.

The content of the aliphatic dicarboxylic acid in the dicarboxylic acid component for forming the crystalline polyester resin unit is preferably 50 mol % or more, more preferably 70 mol % or more, still more preferably 80 mol % or more, particularly preferably 100 mol %. Such a dicarboxylic acid component containing 50 mol % or more aliphatic dicarboxylic acid can contribute to sufficient crystallinity of the crystalline polyester resin unit.

A diol component preferably used is an aliphatic diol. The diol component may contain an optional diol other than the aliphatic diol. A linear aliphatic diol is preferably used. Use of the linear aliphatic diol advantageously enhances the crystallinity crystalline polyester resin unit. These diol components may be used alone or in combination.

Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-dodecanediol, 1,11-undecanediol, 1,12-dodecanediol, 1,13-tridecanediol, 1,14-tetradecanediol, 1,18-octadecanediol, and 1,20-eicosanediol.

Among these aliphatic diols, preferred diol components are aliphatic diols having 2 to 12 carbon atoms. More preferred are aliphatic diols having 6 to 12 carbon atoms, which contributes to the advantageous effects of the present invention, as described above.

Examples of the optional diol other than the aliphatic diol include diols having double bonds and those having sulfonate groups. Specific examples of the diols having double bonds include 2-butene-1,4-diol, 3-butene-1,6-diol, and 4-butene-1,8-diol.

The content of the aliphatic diol in the diol component for forming the crystalline polyester resin unit is preferably 50 mol % or more, more preferably 70 mol % or more, still more preferably 80 mol % or more, particularly preferably 100 mol %. Such a diol component containing 50 mol % or more aliphatic diol can contribute to the crystallinity of the crystalline polyester resin unit, resulting in a toner having excellent low-temperature fixing characteristics and gloss in images finally formed.

In use of the diol component and the dicarboxylic acid component, the equivalent ratio [OH]/[COOH] of the hydroxyl group [OH] of the diol component to the carboxy group [COOH] of the dicarboxylic acid component is preferably 1.5/1 to 1/1.5, more preferably 1.2/1 to 1/1.2.

The crystalline polyester resin unit can be formed by any process. The unit can be formed through polycondensation (esterification) of a polyvalent carboxylic acid and a polyhydric alcohol in the presence of a known esterification catalyst.

Examples of the catalyst usable in preparation of the crystalline polyester resin unit include compounds of alkali metals, such as sodium and lithium; compounds of alkaline earth metals, such as magnesium and calcium; compounds of metals, such as aluminum, zinc, manganese, antimony, titanium, tin, zirconium, and germanium; phosphorous acid compounds; phosphoric acid compounds; and amine compounds.

Specific examples of the tin compounds include dibutyltin oxide, tin octylate, tin dioctylate, and salts thereof. Examples of the titanium compounds include titanium alkoxides, such as tetranormal butyl titanate, tetraisopropyl titanate, tetramethyl titanate, and tetrastearyl titanate; titanium acylate, such as poly(hydroxytitaniumstearate); and titanium chelates, such as titanium tetraacetylacetonate, titanium lactate, and titanium triethanol aminato. Examples of the germanium compounds include germanium dioxide. Examples of the aluminum compounds include oxides, such as poly(aluminum hydroxide); aluminum alkoxides; and tributyl aluminate. These compounds may be used alone or in combination.

Polymerization can be performed at any temperature. A preferred polymerization temperature is within the range of 150 to 250° C. Polymerization can also be performed for any hour, preferably within the range of 0.5 to 10 hours. Polymerization can be performed under a reduced inner pressure of the reaction system.

The components contained in the respective units in the hybrid resin and their proportions can be determined by NMR or methylation reaction pyrolyzer-gas chromatography/mass spectrometry (Py-GC/MS), for example.

The hybrid resin contains the crystalline polyester resin unit and an amorphous resin unit composed of a resin, which will be described in detail later. The hybrid resin can be any one of block copolymers and graft copolymers composed of the crystalline polyester resin unit and the amorphous resin unit. A preferred hybrid resin is a graft copolymer. Such a graft copolymer facilitates control of the orientation of the crystalline polyester resin unit, resulting in a hybrid resin having sufficient crystallinity.

Furthermore, the crystalline polyester resin unit is preferably grafted to the main chain of the amorphous resin unit from the above-described viewpoint. In other words, the hybrid crystalline polyester resin is preferably a graft copolymer composed of the main chain of the amorphous resin unit and the side chain of the crystalline polyester resin unit.

Such a configuration can enhance the orientation of the crystalline polyester resin unit to enhance the crystallinity of the hybrid resin.

The hybrid resin may have a substituent introduced thereinto, such as a sulfonate group, a carboxy group, or a urethane group. The substituent can be introduced into the crystalline polyester resin unit or in the amorphous resin unit, which will be described in detail below.

### (Amorphous Resin Unit in Hybrid Resin)

The amorphous resin unit refers to a portion of the hybrid resin derived from an amorphous resin other than the crystalline polyester resin. The amorphous resin unit controls the affinity of the hybrid resin with the amorphous resin contained in the binder resin. The presence of the amorphous resin unit can enhance the affinity of the hybrid resin with the amorphous resin contained in the binder resin to facilitate embedment of the hybrid resin into the amorphous resin contained in the binder resin, resulting enhanced charging uniformity.

The amorphous resin unit is a portion derived from an amorphous resin other than the crystalline polyester resin. The amorphous resin unit contained in the hybrid resin (and in the toner) can be confirmed through identification of the chemical structure by NMR or methylation reaction Py-GC/MS.

The results of the differential scanning calorimetry (DSC) performed on a resin having the same chemical structure and the same molecular weight as those of the amorphous resin unit show that the resin has no melting point but has a relatively high glass transition temperature (Tg). In the DSC of the resin having the same chemical structure and the same molecular weight as those of the amorphous resin unit, the glass transition temperature (Tg1) in the first heating process is within the range of preferably 30 to 80° C., particularly preferably 40 to 65° C.

Any amorphous resin unit defined above can be used. For example, if toners contain resins having a structure composed of the main chain of the amorphous resin unit copolymerized with another component and resins having a structure composed of the amorphous resin unit copolymerized with the main chain of another component, these resins correspond to the hybrid resin having the amorphous resin unit according to the present invention because these resins have the amorphous resin unit.

The amorphous resin unit is preferably composed of a resin similar to the amorphous resin contained in the binder resin (namely, resin other than the hybrid resin). Such an amorphous resin unit more significantly enhances the affinity of the hybrid resin with the amorphous resin. As a result, the hybrid resin more readily merges into the amorphous resin to more significantly enhance charging uniformity.

Throughout the specification, the term “similar resins” indicates resins having the same characteristic chemical bond in their repeating units. Throughout the specification, the term “characteristic chemical bond” is defined according to “Polymer classification” of Materials Database of National Institute for Materials Science (NIMS) (http://polymer.nims.go.jp/PoLyInfo/guide/jp/term_polymer.html). Namely, the “characteristic chemical bonds” include chemical bonds in 22 polymers in total, i.e., polyacrylic, polyamide, polyacid anhydride, polycarbonate, polydiene, polyester, polyharoolefin, polyimide, polyimine, polyketone, polyolefin, polyether, polyphenylene, polyphosphazene, polysiloxane, polystyrene, polysulfide, polysulfone, polyurethane, polyurea, polyvinyl, and other polymers.

When a resin is a copolymer, the term “similar resins” indicates those resins that have the same characteristic chemical bond in in their repeating units of monomer components in the copolymer. Accordingly, resins at least having the same characteristic chemical bond are regarded as similar resins, irrespective of the difference in characteristics of the resins or the molar ratio of the monomer components in the copolymer.

For example, a resin (or resin unit) composed of styrene, butyl acrylate, and acrylic acid and a resin (or resin unit) composed of styrene, butyl acrylate, and methacrylic acid have at least a chemical bond forming polyacrylate, and thus are regarded as similar resins. In another example, a resin (or resin unit) composed of styrene, butyl acrylate, and acrylic acid and a resin (or resin unit) composed of styrene, butyl acrylate, acrylic acid, terephthalic acid and fumaric acid have at least the same chemical bond forming polyacrylate. Accordingly, these are regarded as similar resins.

The amorphous resin unit can be formed of any resin component. Examples of the resin component include vinyl resin units, urethane resin units, and urea resin units. Among these resin units, preferred are vinyl resin units, the thermoplasticity of which can readily be controlled.

Any vinyl resin unit prepared through polymerization of vinyl compounds can be used. Examples thereof include acrylic acid ester resin units, styrene-acrylic acid ester resin units, and ethylene-vinyl acetate resin units. These vinyl resin units may be used alone or in combination.

Among these vinyl resin units, preferred are styrene-acrylic acid ester resin units (styrene-acrylic resin units) to form domains of the plasticizer having a homogeneous and minute nanostructure. Accordingly, the styrene-acrylic resin unit as the amorphous resin unit will be described below.

The styrene-acrylic resin unit is prepared through addition polymerization of at least a styrene monomer and a (meth)acrylate ester monomer. The styrene monomer herein includes styrene, represented by the formula CH₂═CH—C₆H₅, and styrene derivatives having known side chains or functional groups in the styrene structures. Examples of the (meth)acrylate ester monomer in the specification include acrylic acid ester and methacrylic acid ester compounds represented by the formula CH₂═CHCOOR (where R is an alkyl group), and ester compounds having known side chains or functional groups in the structures of acrylic acid ester or methacrylic acid ester derivatives.

Non-limiting specific examples of the styrene monomers and the (meth)acrylate ester monomers allowing formation of the styrene-acrylic resin unit used in the present invention are listed below.

Specific examples of the styrene monomers include styrene, o-methylstyrene, m-methylstyrene, p-methylstyrene, β-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene. These styrene monomers may be used alone or in combination.

Specific examples of the (meth)acrylate ester monomers include acrylate ester monomers, such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; and methacrylate esters, such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate.

Throughout the specification, the term “(meth)acrylate ester monomers” collectively indicates “acrylate ester monomers” and “methacrylate ester monomers”. For example, “methyl (meth)acrylate” collectively represents “methyl acrylate” and “methyl methacrylate”.

These acrylate or methacrylate ester monomers maybe used alone or in combination. In other words, the copolymer can be formed with one styrene monomer in combination with two or more acrylate ester monomers, one styrene monomer in combination with two or more methacrylate ester monomers, or one styrene monomer in combination with one acrylate ester monomer and one methacrylate ester monomer.

The content of the structural unit derived from the styrene monomer in the amorphous resin unit is preferably within the range of 40 to 90 mass % of the total amount of the amorphous resin unit. The content of the structural unit derived from the (meth)acrylate ester monomer in the amorphous resin unit is preferably within the range of 10 to 60 mass % of the total amount of the amorphous resin unit. These structural units having contents within such ranges facilitate control of the hybrid resin.

Furthermore, the amorphous resin unit is preferably prepared through addition polymerization of the styrene monomer, the (meth)acrylate ester monomer, and a compound for chemically bonding to the crystalline polyester resin unit. Particularly preferred is use of a compound ester-bonded to the hydroxyl group [—OH] derived from the polyhydric alcohol or the carboxyl group [—COOH] derived from the polyvalent carboxylic acid contained in the crystalline polyester resin unit. Accordingly, the amorphous resin unit is preferably prepared through polymerization of the styrene monomer, the (meth)acrylate ester monomer, and further a compound enabling addition polymerization to the styrene monomer and the (meth)acrylate ester monomer and having a carboxyl group [—COOH] or a hydroxyl group [—OH].

Examples of such a compound include compounds having carboxyl groups, such as acrylic acid, methacrylic acid, maleic acid, itaconic acid, cinnamic acid, fumaric acid, monoalkyl maleate ester, and monoalkyl itaconate ester; and compounds having hydroxyl groups, such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, and polyethylene glycol mono(meth)acrylate.

The content of the structural unit derived from the compound in the amorphous resin unit is preferably within the range of 0.5 to 20 mass % of the total amount of the amorphous resin unit.

The styrene-acrylic resin unit can be prepared by any method. Examples thereof include a method of polymerizing monomers with a known oil- or water-soluble polymerization initiator. Specific examples of the oil-soluble polymerization initiator include azo or diazo polymerization initiators and peroxide polymerization initiators listed below.

Examples of the azo or diazo polymerization initiators include 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile.

Examples of the peroxide polymerization initiators include benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxycyclohexyl) propane, and tris-(t-butylperoxy)triazine.

A water-soluble radical polymerization initiator can be used in preparation of resin particles by emulsion polymerization. Examples of the water-soluble polymerization initiator include persulfates, such as potassium persulfate and ammonium persulfate; azobisaminodipropane acetate; azobiscyanovaleric acid and salts thereof; and hydrogen peroxide.

The content of the amorphous resin unit is preferably 20 mass % or less of the total amount of the hybrid resin. Such a content of the amorphous resin unit results in a plasticizer having sufficient crystallinity and formation of more homogeneous domains.

### (Preparation of Hybrid Resin)

The hybrid resin according to the present invention can be prepared by any process which can prepare a polymer having a structure composed of the crystalline polyester resin unit and the amorphous resin unit molecularly bonded thereto. Specific examples of the process of preparing the hybrid resin include the following processes (1) to (3).

### (1) Process of Preliminarily Preparing an Amorphous Resin Unit Through Polymerization, and Preparing a Crystalline Polyester Resin Unit Through a Polymerization Reaction in the Presence of the Amorphous Resin Unit to Prepare a Hybrid Resin

In this process, the monomers forming the amorphous resin unit (preferably, a styrene monomer and a vinyl monomer, such as a (meth)acrylate ester monomer) are formed into an amorphous resin unit through an addition reaction. A polyvalent carboxylic acid and a polyhydric alcohol are formed into a crystalline polyester resin unit through a polymerization reaction in the presence of the amorphous resin unit. At this time, while a condensation reaction of the polyvalent carboxylic acid and the polyhydric alcohol is being performed, an addition reaction of the polyvalent carboxylic acid or the polyhydric alcohol to the amorphous resin unit is performed to prepare a hybrid resin.

In this process, a site enabling the reaction of the crystalline polyester resin unit and the amorphous resin unit is preferably incorporated into the crystalline polyester resin unit or the amorphous resin unit.

Specifically, the monomers forming the amorphous resin unit and a compound having a site reactive with a carboxy group [—COOH] or a hydroxyl group [—OH] remaining in the crystalline polyester resin unit and a site reactive with the amorphous resin unit are used in preparation of the amorphous resin unit. Namely, this compound can react with the carboxy group [—COOH] or the hydroxyl group [—OH] in the crystalline polyester resin unit to chemically bond the crystalline polyester resin unit to the amorphous resin unit.

Alternatively, a compound having a site reactive with the polyhydric alcohol or the polyvalent carboxylic acid and reactive with the amorphous resin unit can be used in preparation of the crystalline polyester resin unit.

This process can prepare a hybrid resin having a structure (graft structure) composed of the crystalline polyester resin unit molecularly bonded to the amorphous resin unit.

### (2) Process of Separately Preparing a Crystalline Polyester Resin Unit and an Amorphous Resin Unit, and Bonding These Units to Prepare a Hybrid Resin

In this process, a polyvalent carboxylic acid and a polyhydric alcohol are formed into a crystalline polyester resin unit through a condensation reaction. Separately from the reaction system for preparing the crystalline polyester resin unit, the monomers forming the amorphous resin unit are formed into an amorphous resin unit through addition polymerization. At this time, a site enabling the reaction of the crystalline polyester resin unit and the amorphous resin unit is preferably incorporated into the crystalline polyester resin unit or the amorphous resin unit. Such a site is incorporated by the process described above, and the redundant description is omitted.

The resulting crystalline polyester unit can be reacted with the amorphous resin unit to prepare a hybrid resin having a structure composed of the crystalline polyester resin unit molecularly bonded to the amorphous resin unit.

If the site enabling the reaction of the crystalline polyester resin unit and the amorphous resin unit is not incorporated into the crystalline polyester resin unit and the amorphous resin unit, a system containing a crystalline polyester resin unit and a co-existing amorphous resin unit may be formed, and a compound having a site enabling bonding of the crystalline polyester resin unit to the amorphous resin unit maybe charged into the system. The crystalline polyester resin unit can be molecularly bonded to the amorphous resin unit through the compound to prepare a hybrid resin having the structure described above.

### (3) Process of Preliminarily Preparing a Crystalline Polyester Resin Unit, and Preparing an Amorphous Resin Unit Through a Polymerization Reaction in the Presence of the Crystalline Polyester Resin Unit to Prepare a Hybrid Resin

In this process, a polyvalent carboxylic acid and a polyhydric alcohol are polymerized through a condensation reaction to prepare a crystalline polyester resin unit. The monomers forming an amorphous resin unit are formed into an amorphous resin unit through a polymerization reaction in the presence of the crystalline polyester resin unit. At this time, as in Process (1), a site enabling the reaction of the crystalline polyester resin unit and the amorphous resin unit is preferably incorporated into the crystalline polyester resin unit or the amorphous resin unit. Such a site is incorporated by the process described above, and the redundant description is omitted.

These processes can prepare a hybrid resin having a structure (graft structure) composed of the amorphous resin unit molecularly bonded to the crystalline polyester resin unit.

Among Processes (1) to (3), preferred is Process (1), which is a simple process and can readily prepare the hybrid resin having a structure composed of the crystalline polyester resin chain grafted to the amorphous resin chain. In Process (1), the amorphous resin unit is preliminarily prepared, and the crystalline polyester resin unit is then bonded to the amorphous resin unit. This process can readily form the crystalline polyester resin unit having uniform orientation. Hence, this process preferably contributes to preparation of a hybrid resin suitable for the toner specified in the present invention.

### (Mold Release Agent)

In the toner according to the present invention, the particulate toner may contain a mold release agent. The mold release agent contained in the particulate toner has low miscibility with the crystalline polyester resin contained in the particulate toner, and readily bleeds out to the surfaces of the particulate toner during the thermal fixing process, resulting in high fixing separation characteristics of the particulate toner.

The content of the mold release agent is preferably 5 to 20 mass % of the total amount of the particulate toner excluding the colorant. Such a content of the mold release agent can prevent a reduction in heat resistance and durability of the toner, and can enhance the post-fixing separability of the toner.

The mold release agent has any average particle size. For example, the mold release agent preferably has a volume median particle size of 3 μm or less.

Usable mold release agents are a variety of known waxes. Preferred are hydrocarbon waxes or ester waxes to enhance the low-temperature fixing characteristics and the releasing characteristics of the toner.

Specific examples of the waxes include hydrocarbon waxes, such as low molecular weight polyethylene waxes, low molecular weight polypropylene waxes, Fischer-Tropsch waxes, microcrystalline waxes, and paraffin waxes; and ester waxes, such as carnauba wax, pentaerythritol behenate, behenyl behenate, and behenyl citrate. These waxes may be used alone or in combination.

Among these waxes, particularly preferred is microcrystalline wax. The microcrystalline wax can readily grow into domains having large aspect ratios without stable crystallization in the toner. Such domains of the microcrystalline wax are unlikely to be exposed to the surface of the particulate toner at normal temperature. These domains of the microcrystalline wax prevent a reduction in heat resistance and durability caused by filming of a photoreceptor and a carrier spent by the toner.

The microcrystalline wax has a branched structure. The steric hindrance derived from the branched structure would probably prevent agglomeration of the microcrystalline wax in the toner, and thus facilitate growing of the microcrystalline wax into domains having large aspect ratios.

Among these microcrystalline waxes, preferred are those having low melting points, specifically a melting point within the range of 40 to 90° C. in view of releasing characteristics during a low-temperature fixing process.

The mold release agent is preferably present in the particulate toner in the form of domains different from and independent of the domains of the plasticizer. The mold release agent and the plasticizer formed into different domains independent of each other readily demonstrate the respective functions.

For example, if a wax (mold release agent) coated with a resin is used in preparation of a toner in an aqueous medium, such a wax (mold release agent) is readily formed into domains different from those of the plasticizer. The plasticizer and the mold release agent present in the form of two independent domains in the matrix without mixing can sufficiently demonstrate their own functions without sacrificing the functions of the plasticizer and mold release agent. Accordingly, the resulting toner can have excellent low-temperature fixing characteristics, post-fixing separability, and offset resistance in use of rough paper.

### (Colorants)

The particulate toner contains a colorant according to the present invention. Usable colorants include a variety of known pigments and dyes.

Examples of such carbon black include, for example, channel black, furnace black, acetylene black, thermal black, lamp black and the like. Examples of such black iron oxide include, for example, magnetite, hematite, iron titanium trioxide and the like.

Examples of such dyes include, for example, C. I. Solvent Red 1, C. I. Solvent Red 49, C. I. Solvent Red 52, C. I. Solvent Red 58, C. I. Solvent Red 63, C. I. Solvent Red 111, C. I. Solvent Red 122, C. I. Solvent Yellow 19, C. I. Solvent Yellow 44, C. I. Solvent Yellow 77, C. I. Solvent Yellow 79, C. I. Solvent Yellow 81, C. I. Solvent Yellow 82, C. I. Solvent Yellow 93, C. I. Solvent Yellow 98, C. I. Solvent Yellow 103, C. I. Solvent Yellow 104, C. I. Solvent Yellow 112, C. I. Solvent Yellow 162, C. I. Solvent Blue 25, C. I. Solvent Blue 36, C. I. Solvent Blue 60, C. I. Solvent Blue 70, C. I. Solvent Blue 93, C. I. Solvent Blue 95 and the like.

Examples of such pigments include, for example, C. I. Pigment Red 5, C. I. Pigment Red 48:1, C. I. Pigment Red 48:3, C. I. Pigment Red 53:1, C. I. Pigment Red 57:1, C. I. Pigment Red 81:4, C. I. Pigment Red 122, C. I. Pigment Red 139, C. I. Pigment Red 144, C. I. Pigment Red 149, C. I. Pigment Red 150, C. I. Pigment Red 166, C. I. Pigment Red 177, C. I. Pigment Red 178, C. I. Pigment Red 222, C. I. Pigment Red 238, C. I. Pigment Red 269, C. I. Pigment Orange 31, C. I. Pigment Orange 43, C. I. Pigment Yellow 14, C. I. Pigment Yellow 17, C. I. Pigment Yellow 74, C. I. Pigment Yellow 93, C. I. Pigment Yellow 94, C. I. Pigment Yellow 138, C. I. Pigment Yellow 155, C. I. Pigment Yellow 156, C. I. Pigment Yellow 158, C. I. Pigment Yellow 180, C. I. Pigment Yellow 185, C. I. Pigment Green 7, C. I. Pigment Blue 15:3, C. I. Pigment Blue 60 and the like.

These coloring agents maybe used alone or in combination of two or more for producing the respective color toners.

The content of the coloring agent in the particulate toner is preferably from 1 mass % to 10 mass %, more preferably from 2 mass % to 8 mass %. The colorant used in a content within this range results in a toner having a desired coloring ability, and can minimize influences on charging properties, which are caused by the colorant detached from the particulate toner or adhering to the carrier.

### (Charge Control Agent)

In the toner for developing electrostatically charged images according to the present invention, the particulate toner preferably contains a charge control agent. Usable charge control agents include a variety of known compounds.

The proportion of the charge control agent is preferably within the range of 0 to 5 mass %, more preferably 0 to 0.5 mass % of the particulate toner.

### (External Additive)

In the toner for developing electrostatically charged images according to the present invention, the particulate toner can be directly used as the toner. However, in order to improve the fluidity, charging characteristics, cleaning property and the like, an external additive such as a so-called fluidizer and a cleaning aid may be added to the particulate toner. A variety of compounds may be used in combination as the external additive.

Such external additives are added in a total amount of preferably 0.05 parts by mass to 5 parts by mass, more preferably 0.1 parts by mass to 3 parts by mass with respect to 100 parts by mass of the particulate toner.

### (Glass Transition Temperature of Toner)

The toner for developing electrostatically charged images according to the present invention has a glass transition temperature (Tg) within the range of preferably 50 to 70° C., more preferably 55 to 65° C.

The toner for developing electrostatically charged images according to the present invention having a glass transition temperature within this range certainly has compatibility between sufficient low-temperature fixing characteristics and heat resistance during storage. It is believed that the toner having a glass transition temperature within this range maintains its heat resistance (thermal strength). Hence, sufficient heat resistance during storage and hot offset resistance are certainly attained.

### (Melting Point of Toner)

The toner for developing electrostatically charged images according to the present invention has a melting point (Tm) within the range of preferably 60 to 90° C., more preferably 65 to 80° C.

The toner for developing electrostatic latent images according to the present invention having a melting point within this range certainly has compatibility between sufficient low-temperature fixing characteristics and heat resistance during storage. It is believed that the toner having a melting point within this range preferably maintains its heat resistance (thermal strength). As a result, sufficient heat resistance during storage can also be ensured.

The glass transition temperature and the melting point of the toner are determined as in the crystalline polyester resin.

### (Particle Size of Particulate Toner)

In the toner for developing electrostatically charged images according to the present invention, the average particle size of the particulate toner given as a volume median particle size is within the range of preferably 3 to 8 μm, more preferably 5 to 8 μm. The average particle size can be controlled by the concentration of a flocculant to be used, the amount of an organic solvent to be added, the fusing time and/or the composition of the binder resin.

The particulate toner having a volume median particle size within this range enable close reproduction of super-fine dot images in order of 1200 dpi.

The volume median particle size of the particulate toner is measured and calculated by using a measuring equipment composed of “MULTISIZER 3” (Beckman Coulter Inc.) and a computer system installed with a data processing software “Software V3.51” connected thereto.

Specifically, 0.02 g of a sample (toner) is added to 20 mL of a surfactant solution (for dispersing the particulate toner, e.g. a surfactant solution prepared by eluting a neutral detergent containing a surfactant component with purified water by 10 times) and is allowed to be uniform, and then the solution is subjected to ultrasonic dispersion for 1 minute. The toner dispersion thus prepared is added to “ISOTON II” (Beckman Coulter Inc.) in a beaker placed in sample stand by a pitette until the concentration displayed on the measuring equipment reaches 8%. Within this concentration range, reproducible measurement values can be obtained.

The measuring particle count and the aperture size of the measuring equipment are set to 25000 and 100 μm respectively. The measuring range, which is from 2 μm to 60 μm, is divided into 256 sections to calculate the respective frequencies. The particle size where the accumulated volume counted from the largest size reaches 50% is determined as the volume median particle size.

### (Average Circularity of Particulate Toner)

In the toner of the present invention, it is preferred that the particulate toner have an average circularity of 0.930 to 1.000, more preferably 0.950 to 0.995 in terms of the stability of the charging characteristics and the low-temperature fixability.

When the average circularity is within the above-described range, the individual toner particles are less crushable. This prevents the triboelectric charge applying member from smudges and stabilizes the charging characteristics of the toners. Further, high quality images can be formed.

The average circularity of the particulate toner is measured by “FPIA-2100” (Sysmex Corp.).

Specifically, a sample (toner) is mixed with an aqueous solution containing a surfactant and is further dispersed by ultrasonication for 1 minute. Thereafter, photographs are taken by means of “FPIA-2100” (Sysmex Corp.) in the conditions of the HPF (high power imaging) mode at an adequate concentration range corresponding to an HPF detect number of 3000 to 10000. The average circularity of the toner is calculated by determining the circularity of each toner particle according to the following Equation (y) and dividing the sum of the circularities of the toner particles by the total number of toner particles. The HPF detect number within the above range achieves reproducibility.

Circularity=(Circumference of circle having same area as projected image of particle)/(Perimeter of projected image of particle) Equation (y)

### (Developer)

The toner for developing electrostatically charged images according to the present invention can be used as a magnetic or non-magnetic one-component developer, or can be used as a two-component developer in the form of a mixture with a carrier.

The carrier usable in the toner as a two-component developer is composed of magnetic particles of a conventional known material, such as a metal (such as iron, ferrite, or magnetite), or an alloy of the metal and another metal (such as aluminum or lead). Particularly preferred are ferrite particles.

The carrier can be a coated carrier composed of magnetic particles having surfaces coated with a coating agent, such as a resin, or a carrier of a dispersion type composed of magnetic nanoparticles dispersed in a binder resin.

The average particle size of the carrier given as a volume median particle size is within the range of preferably 20 to 100 μm, more preferably 25 to 80 μm.

The volume median particle size of the carrier can be typically determined with a laser diffraction particle diameter distribution analyzer HELOS (available from SYMPATEC GmbH) provided with a wet disperser.

### <<Process of Preparing Toner>>

Examples of the process of preparing a toner include a wet process of preparing a toner in an aqueous medium, such as emulsion aggregation.

In preparation of the toner by emulsion aggregation, for example, nanoparticles of a binder resin (hereinafter, also referred to as “binder resin nanoparticles”) are dispersed in an aqueous medium to prepare an aqueous dispersion, and nanoparticles of a colorant (hereinafter, also referred to as “colorant nanoparticles”) are dispersed in an aqueous medium to prepare an aqueous dispersion. These aqueous dispersions are mixed. The binder resin nanoparticles and the colorant nanoparticles are aggregated, and are thermally fused to form a particulate toner. A toner is thereby prepared.

An exemplary process of preparing a toner involves the following steps:

(a) a step of preparing Particulate toner precursor (I),

(b) a step of preparing Particulate toner precursor (II),

(c) a step of preparing Particulate toner precursor (III),

(d) a step of dispersing nanoparticles of a crystalline polyester resin (plasticizer) (hereinafter, also referred to as “crystalline polyester resin nanoparticles”) in an aqueous medium to prepare an aqueous dispersion,

(e) a step of dispersing colorant nanoparticles in an aqueous medium to prepare an aqueous dispersion,

(f) a step of forming a particulate toner,

(g) a step of cooling the dispersion of the particulate toner,

(h) a step of separating the particulate toner from the aqueous medium through filtration to remove a surfactant from the particulate toner,

(i) a step of drying the cleaned particulate toner, and

(j) an optional step of adding an external additive to the dry particulate toner.

Throughout the specification, the term “aqueous dispersion” indicates a state of a nanoparticulate substance dispersed in an aqueous medium, and the aqueous medium indicates a medium containing mainly (50 mass % or more) water.

Examples of the components other than water include water-soluble organic solvents, such as methanol, ethanol, isopropanol, butanol, acetone, methyl ethyl ketone, and tetrahydrofuran. Among these organic solvents, particularly preferred are alcoholic organic solvents, such as methanol, ethanol, isopropanol, and butanol, which do not dissolve resins.

### (a) Preparation of Particulate Toner Precursor (I) (First Polymerization)

In this step, Particulate toner precursor (I) is prepared through emulsion polymerization according to a standard method.

Specifically, a polymerization initiator is added to a surfactant solution, and the solution is heated. While the solution is being stirred, a polymerizable monomer solution is added dropwise to perform a reaction.

The reaction temperature is preferably within the range of 70 to 90° C., for example.

The average particle size of Particulate toner precursor (I) given as a volume median particle size is preferably within the range of 50 to 150 nm. The volume median particle size of the particulate toner precursor is determined with UPA-150 (made by Microtrac, Inc.).

### (b) Preparation of Particulate Toner Precursor (II) (Second Polymerization)

In this step, a polymerizable monomer containing a polymerization initiator and a mold release agent is added to the dispersion of Particulate toner precursor (I) prepared through first polymerization to prepare Particulate toner precursor (II).

Specifically, a surfactant solution is added to a mixed solution of the dispersion of Particulate toner precursor (I). The resulting solution and a polymerizable monomer containing a mold release agent dissolved therein are heated, and are dispersed by mixing with a mechanical disperser. A polymerization initiator is added, and the solution is polymerized by stirring under heating.

The amount of the aqueous medium used for dispersion of Particulate toner precursor (I) is preferably within the range of 5 to 50 parts by mass of the total solvent used in second polymerization to produce a toner maintaining compatibility between elasticity at high temperature and low-temperature fixing characteristics.

The reaction temperature is preferably within the range of 70 to 95° C., for example.

### (c) Preparation of Particulate Toner Precursor (III) (Third Polymerization)

In this step, a polymerizable monomer is added to the dispersion of Particulate toner precursor (II) prepared through second polymerization to prepare Particulate toner precursor (III).

Specifically, a polymerization initiator is added to a heated dispersion of Particulate toner precursor (II). A polymerizable monomer is added dropwise under heating to perform polymerization.

The reaction temperature is preferably within the range of 70 to 95° C., for example.

### (d) Preparation of Aqueous Dispersion of Crystalline Polyester Resin Nanoparticles

In this step, a crystalline polyester resin is used to prepare an aqueous dispersion of crystalline polyester resin nanoparticles.

A crystalline polyester resin is synthesized, and is dispersed in an aqueous medium in the form of nanoparticles to prepare an aqueous dispersion of crystalline polyester resin nanoparticles.

A typical process of dispersing the crystalline polyester resin in the aqueous medium involves dissolving or dispersing the crystalline polyester resin in an organic solvent to prepare an oil phase solution or dispersion, dispersing the oil phase solution or dispersion in an aqueous medium through phase inversion emulsification or the like to prepare oil droplets having a desired size, and removing the organic solvent.

The aqueous medium is preferably used in an amount within the range of 50 to 2000 parts by mass, more preferably 100 to 1000 parts by mass relative to 100 parts by mass of the oil phase solution or dispersion.

A surfactant may be added to the aqueous medium to enhance the dispersion stability of the oil droplets. Usable surfactants include a variety of known anionic, cationic, and non-ionic surfactants.

Preferred organic solvents used in preparation of the oil phase solution or dispersion are those having low boiling points and low solubilities in water because such organic solvents are readily removed after preparation of oil droplets. Specific examples of such organic solvents include methyl acetate, ethyl acetate, methyl ethyl ketone, methyl isobutyl ketone, toluene, and xylene. These organic solvents can be used alone or in combination. The amount of the organic solvent used is within the range of usually 1 to 300 parts by mass, preferably 1 to 100 parts by mass, more preferably 25 to 70 parts by mass relative to 100 parts by mass of the crystalline polyester resin.

The oil phase solution or dispersion can be emulsified by mechanical energy in any disperser. Examples of the disperser include low speed shear dispersers, high speed shear dispersers, frictional dispersers, high pressure jet dispersers, and ultrasonic dispersers, such as TK homomixer (made by Tokushu Kika Kogyo Co., Ltd.).

The oil droplets dispersed has a diameter within the range of preferably 60 to 1000 nm, more preferably 80 to 500 nm.

The diameter of oil droplets dispersed indicates a volume median particle size determined with a laser diffraction/scattering particle size distribution analyzer LA-750 (made by HORIBA, Ltd.). The diameter of oil droplets dispersed can be controlled through the adjustment of mechanical energy during emulsion by dispersion.

The average particle size of the crystalline polyester resin nanoparticles given as a volume median particle size is preferably within the range of 50 to 500 nm.

The volume median particle size of the crystalline polyester resin nanoparticles is determined with Microtrac UPA-150 (made by NIKKISO CO., LTD.).

### (e) Step of Preparing Aqueous Colorant Nanoparticle Dispersion

This step is performed when necessary in preparation of particulate toner containing a colorant. A colorant is dispersed in an aqueous medium in the form of nanoparticles to prepare an aqueous colorant nanoparticle dispersion.

The aqueous colorant nanoparticle dispersion is prepared by dispersing a colorant in an aqueous medium containing a surfactant in the critical micelle concentration (CMC) or more.

The colorant can be dispersed by mechanical energy in any disperser. Preferred examples of the disperser include ultrasonic dispersers; mechanical homogenizers; pressurized dispersers, such as Manton-Gaulin homogenizers and pressurized homogenizers; and medium dispersers, such as sand grinders, getsman mills, and diamond fine mills.

The colorant nanoparticles dispersed has a volume median particle size within the range of preferably 10 to 300 nm, more preferably 100 to 200 nm, particularly preferably 100 to 150 nm.

The volume median particle size of the colorant nanoparticles is determined with an electrophoretic light scattering photometer ELS-800 (made by Otsuka Electronics Co., Ltd.).

### (f) Formation of Particulate Toner

In this step, the crystalline polyester resin nanoparticles and the colorant nanoparticles are aggregated on the surface of Particulate toner precursor (III) prepared through third polymerization, and are fused by heating to form a particulate toner.

Specifically, Particulate toner precursor (III), the crystalline polyester resin nanoparticles, and the colorant nanoparticles are dispersed in an aqueous medium to prepare an aqueous dispersion, and a flocculant is added to the aqueous dispersion in the critical aggregation concentration or more. The mixed solution is heated to aggregate and fuse these nanoparticles. In this aggregation and fusing step, the aspect ratios of the domains of the mold release agent and the domains of the plasticizer in the particulate toner are controlled according to the amounts of the raw materials for the mold release agent, the plasticizer (crystalline polyester resin), and the binder resin to be added, the reaction time (stirring time), and the heating temperature.

Preferably, the crystalline polyester resin nanoparticles are added at a temperature between 70° C. and 90° C. after Particulate toner precursor (III) and the colorant nanoparticles are aggregated.

The fusing temperature is preferably within the range of 70 to 95° C., for example.

### (Coagulant)

The coagulant used may be any coagulant but is preferably selected from metal salts, such as salts of alkaline metals or alkaline earth metals.

Such metal salts include, for example, monovalent metal salts such as sodium, potassium and lithium; divalent metal salts such as salts of calcium, magnesium, manganese and copper; trivalent metal salts such as salts of iron and aluminum; and the like.

Specific examples of such metal salts include sodium chloride, potassium chloride, lithium chloride, calcium chloride, magnesium chloride, zinc chloride, copper sulfate, magnesium sulfate, manganese sulfate and the like. Among them, divalent metal salts are particularly preferred since the aggregation is caused by a smaller amount. These coagulants may be used alone or in combination.

The process of preparing a toner preferably involves the step of forming a particulate toner and an aging step.

In the aging step, the particulate toner prepared through the step of forming a particulate toner is aged by thermal energy until a desired shape is obtained.

Specifically, the system including the particulate toner dispersed is stirred under heating to age the particulate toner until the particulate toner has a desired circularity, while the heating temperature, the stirring rate, and the heating time are being controlled.

### (g) Cooling

In this step, the dispersion of the particulate toner is cooled.

This cooling step is preferably performed at a cooling rate of 1 to 20° C./min. The cooling can be performed by any method, for example, a method of introducing a coolant into a reaction container to cool the dispersion of particulate toner, or a method of directly feeding cooling water to a reaction system to cool the dispersion of the particulate toner.

### (h) Filtration and Cleaning

In this step, the particulate toner is subjected to solid liquid separation from the cooled dispersion of the particulate toner, and adhering substances, such as a surfactant and a flocculant, are removed from the toner cake extracted through solid liquid separation (wet particulate toner agglomerated in the form of a cake) to clean the toner cake.

Solid liquid separation can be performed by any method, such as filtration under reduced pressure through centrifugation or a suction funnel or filtration with a filter press. In cleaning, the toner cake is preferably washed with water until the electric conductivity of the filtrate decreases to 10 μS/cm.

### (i) Drying

In this step, the cleaned toner cake is dried by a drying step usually performed in a known process of preparing a particulate toner.

Specific examples of a dryer used for drying of the toner cake include spray dryers, vacuum freeze dryers, and reduced pressure dryers. Preferred is use of dryers with fixed shelfs, dryers with movable shelfs, fluid layer dryers, rotary dryers, and stirring dryers.

The moisture content of the dry particulate toner is preferably 5 mass % or less, more preferably 2 mass % or less. The dry particulate toner agglomerated with a weak interparticle attractive force may be disintegrated. Usable disintegrators include mechanical crushers, such as jet mills, Henschel mixers, coffee mills, and food processors.

### (j) Addition of External Additive

In this optional step, an external additive is added to the particulate toner.

The particulate toner described above can be used as a toner as they are. The particulate toner may contain external additives, such as a fluidizing agent and a cleaning aid to have enhanced fluidity, charging characteristics, and cleaning characteristics.

A variety of external additives can be used in combination.

These external additives are added in a total amount within the range of preferably 0.05 to 5 parts by mass, more preferably 0.1 to 3 parts by mass relative to 100 parts by mass of the particulate toner.

The external additives can be mixed with the particulate toner in a mechanical mixer, such as a Henschel mixer or a coffee mill.

The particulate toner according to the present invention may further contain an amorphous polyester resin. Containing an amorphous polyester resin contributes to excellent heat-resistant storage characteristics. In addition, being miscible with the crystalline polyester resin contributes to low-temperature fixing characteristics.

### EXAMPLES

The present invention will now be described in detail by way of non-limiting Examples. In Examples, “parts” and “%” are on the mass basis, unless otherwise specified.

A process of preparing Toner 1 will now be described in detail.

### <<Preparation of Toner>>

<Preparation of Aqueous Dispersion [M1] of Resin Nanoparticles [m1] Containing Mold Release Agent>

### (First Polymerization)

Sodium dodecyl sulfate (8 g) and deionized water (3 L) were placed in a 5 L reaction container provided with a stirrer, a temperature sensor, a cooling tube, and a nitrogen inlet, and the inner temperature were raised to 80° C. with stirring at a stirring rate of 230 rpm under a nitrogen stream. After heating, a solution of potassium persulfate (10 g) in deionized water (200 g) was added, and the solution was again heated to 80° C. A mixed monomer solution comprising:

| | |
|---|---|
| Styrene (St) | 480 g |
| n-Butyl acrylate (BA) | 250 g |
| Methacrylic acid (MAA) | 68 g |

was added dropwise over one hour, and the mixed solution was heated at 80° C. for two hours with stirring to perform polymerization. Dispersion [x1] of resin nanoparticles was thereby prepared.

### (Second Polymerization)

A solution of sodium polyoxyethylene(2) dodecyl ether sulfate (7 g) in deionized water (3 L) was placed in a 5 L reaction container provided with a stirrer, a temperature sensor, a cooling tube, and a nitrogen inlet, and was heated to 98° C. A solution prepared at 90° C. of Dispersion [x1] of resin nanoparticles (280 g), the following monomers, and the following mold release agent:

| | |
|---|---|
| Styrene (St) | 256 g |
| n-Butyl acrylate (BA) | 115 g |
| Methacrylic acid (MAA) | 21 g |
| n-Octyl-3-mercaptopropionate | 5 g |
| Mold release agent: microcrystalline wax | 124 g |
| (melting point: 73° C.) | |

was added to the container. The solution was mixed and dispersed with a mechanical disperser “CLEARMIX” having a circulation path (made by M Technique Co., Ltd.) for one hour to prepare a dispersion containing emulsified particles (oil droplets).

An initiator solution of potassium persulfate (6 g) dissolved in deionized water (200 mL) was added to this dispersion. This system was heated at 84° C. for one hour with stirring to prepare Dispersion [x2] of resin nanoparticles.

### (Third Polymerization)

Deionized water (400 mL) was added to Dispersion [x2] of resin nanoparticles, and was sufficiently mixed therewith. A solution of potassium persulfate (11 g) in deionized water (400 mL) was then added to Dispersion [x2] of resin nanoparticles. A monomer mixed solution comprising:

| | |
|---|---|
| Styrene (St) | 435 g |
| n-Butyl acrylate (BA) | 157 g |
| Methacrylic acid (MAA) | 41 g |
| n-Octyl-3-mercaptopropionate | 13 g |

was added dropwise at 82° C. over one hour. The solution was then heated for two hours with stirring to perform polymerization. The solution was cooled to 28° C. to prepare Aqueous dispersion [M1] of Resin nanoparticles [m1] composed of a vinyl resin.

In Aqueous dispersion [M1] of Resin nanoparticles [m1], Resin nanoparticles [m1] had a volume median particle size of 220 nm, a glass transition temperature (Tg) of 55° C., and a weight average molecular weight (Mw) of 38000.

<Preparation of Aqueous Dispersions [M2] To [M7] of Resin Nanoparticles [m2] To [m7] Containing Mold Release Agent>

Dispersions [M2] to [M6] of Resin nanoparticles [m2] to [m6] were prepared as in preparation of Aqueous dispersion [M1] of Resin nanoparticles [m1] except that the amount of the mold release agent (microcrystalline wax (melting point: 73° C.)) used in the second polymerization was varied. In detail, Resin nanoparticles [m2], [m3], [m4], [m5], and [m6] were prepared while the amount of the mold release agent (microcrystalline wax (melting point: 73° C.)) was varied to 235 g, 71 g, 140 g, 200 g, 170 g, and 115 g, respectively. Aqueous dispersions [M2], [M3], [M4], [M5], and [M6] were then prepared with Resin nanoparticles [m2], [m3], [m4], [m5], and [m6], respectively.

Resin nanoparticles [m7] were prepared as in the second polymerization in preparation of Aqueous dispersion [M1] of Resin nanoparticles [m1] except that the microcrystalline wax (melting point : 73° C.) (124 g) was replaced with behenyl behenate (melting point : 73° C.) (140g). Aqueous dispersion [M7] of Resin nanoparticles [m7] was prepared as in preparation of Aqueous dispersion [M1] of Resin nanoparticles [m1].

### <Preparative Example of Aqueous Dispersion [Bk] of Colorant Nanoparticles>

Sodium dodecyl sulfate (90 g) was dissolved in deionized water (1600 g) with stirring. While this solution was being stirred, carbon black “REGAL 330R” (made by Cabot Corporation) (420 g) was gradually added, and was dispersed with a stirrer “Cleamix” (made by M Technique Co., Ltd.) to prepare Dispersion [Bk] of Colorant nanoparticles [bk]. In Dispersion [Bk] of Colorant nanoparticles [bk], the volume median particle size of Colorant nanoparticles [bk] was determined with an electrophoretic light scattering photometer “ELS-800” (made by Otsuka Electronics Co., Ltd.). Colorant nanoparticles [bk] had a volume median particle size of 120 nm.

<Preparation of Aqueous Dispersion [C1] of Resin Nanoparticles [c1] Containing Plasticizer>
(Preparation of Resin Nanoparticles [c1])

The following raw material monomers for an addition-polymerized resin (styrene-acrylic resin: StAc) unit including a bi-reactive monomer and the following radical polymerization initiator were placed in a dropping funnel.

| | |
|---|---|
| Styrene | 43 parts by mass |
| n-Butyl acrylate | 15 parts by mass |
| Acrylic acid | 6 parts by mass |
| Polymerization initiator (di-t-butyl peroxide) | 7 parts by mass |

The following raw material monomers for a polycondensation resin (crystalline polyester resin: CPEs) unit was placed in a four-necked flask provided with a nitrogen inlet, a dehydration tube, a stirrer, and a thermocouple, and was dissolved at 170° C.

| | |
|---|---|
| Sebacic acid | 281 parts by mass |
| 1,12-Dodecanediol | 283 parts by mass |

In the next step, the raw material monomers for an addition-polymerized resin (styrene-acrylic resin: StAc) unit and the radical polymerization initiator in the dropping funnel were added dropwise over 90 minutes with stirring. The solution was aged for 60 minutes, and the non-reacted monomers were removed under reduced pressure (8 kPa). A slight amount of the non-reacted monomers was removed relative to the total amount of the raw material monomers for an addition-polymerized resin.

An esterification catalyst Ti (OBu)₄ (0.8 parts by mass) was then added to the reaction system. The reaction system was heated to 235° C. to promote a reaction under normal pressure (101.3 kPa) for five hours, and further under reduced pressure (8 kPa) for one hour.

After the reaction system was cooled to 200° C., the reaction was continued under reduced pressure (20 kPa) for one hour to prepare Resin nanoparticles [c1] of hybrid resin. The hybrid resin or Resin nanoparticles [c1] contained 10 mass % styrene-acrylic resin unit relative to the total amount of Resin nanoparticles [c1]. This nanoparticulate hybrid resin was composed of styrene-acrylic resin units to which crystalline polyester resin units were grafted. Resin nanoparticles [c1] had a number average molecular weight (Mn) of 9000 and a melting point (Tc) of 76° C.

(Preparation of Aqueous Dispersion [C1] of Resin Nanoparticles [c1])

Resin nanoparticles [c1] (72 parts by mass) prepared through the process described above were dissolved in methyl ethyl ketone (72 parts by mass) with stirring at 70° C. for 30 minutes. An aqueous solution (2.5 parts by mass) of 25 mass % sodium hydroxide was added to this solution. The solution was placed in a reaction container provided with a stirrer. While the solution was being stirred, water (252 parts by mass) heated to 70° C. was added dropwise over 70 minutes to prepare a mixed solution. The solution in the container became cloudy during addition of water. Addition of the total amount of water generated a homogeneous emulsion. The particle sizes of oil droplets in this emulsion were determined with a laser diffraction particle size distribution analyzer “LA-750 (made by HORIBA, Ltd.)”. The oil droplets had a volume average particle size of 123 nm.

In the next step, while the emulsion was kept at 70° C., the emulsion was stirred with a diaphragm vacuum pump “V-700” (made by BUCHI Labortechnik AG) under a reduced pressure of 15 kPa (150 mbar) for three hours to distill off methyl ethyl ketone. Aqueous dispersion [C1] of Resin nanoparticles [c1] was thereby prepared. Resin nanoparticles [c1] had a volume average particle size of 75 nm, which was determined with the particle size distribution analyzer.

<Preparation of Aqueous Dispersions [C2] to [C4] of Resin Nanoparticles [c2] to [c4] Containing Plasticizer>
(Preparation of Resin Nanoparticles [c2] to [c4])

Resin nanoparticles [c2] to [c4] were prepared as in preparation of Resin nanoparticles [c1] except that only the amounts of the raw material monomers (styrene, n-butyl acrylate, and acrylic acid) for an addition-polymerized resin (styrene-acrylic resin: StAc) unit were varied as shown in Table 1. As shown in Table 1, Resin nanoparticles [c2], [c3], and [c4] contained 20 mass %, 0 mass %, and 5 mass % styrene-acrylic resin unit, respectively.

TABLE 1

| | | | | Content of |
|---|---|---|---|---|
| | | | | styrene-acrylic |
| | | n-Butyl | | resin unit |
| Resin | Styrene | acrylate | Acrylic acid | in resin |
| nanoparticle | [Parts by | [Parts by | [Parts by | nanoparticles |
| No. | mass] | mass] | mass] | [Mass %] |
| c1 | 43 | 15 | 6 | 10 |
| c2 | 86 | 45 | 12 | 20 |
| c3 | 0 | 0 | 0 | 0 |
| c4 | 21 | 7 | 2 | 5 |

(Preparation of Aqueous Dispersion [C2] to [C4] of Resin Nanoparticles [c2] to [c4])

Aqueous dispersions [C2] to [C4] of Resin nanoparticles [c2] to [c4] were prepared as in preparation of Aqueous dispersion [C1] of Resin nanoparticles [c1].

### <Preparation of Aqueous Dispersion [S1] of Amorphous Resin Nanoparticles>

The following raw material monomers for an addition-polymerized resin (styrene-acrylic resin: StAc) unit including a bi-reactive monomer and the following radical polymerization initiator were placed in a dropping funnel.

| | |
|---|---|
| Styrene | 80 parts by mass |
| n-Butyl acrylate | 20 parts by mass |
| Acrylic acid | 10 parts by mass |
| Polymerization initiator (di-t-butyl peroxide) | 16 parts by mass |

The following raw material monomers for a polycondensation resin (amorphous polyester resin) unit were placed in a four-necked flask provided with a nitrogen inlet, a dehydration tube, a stirrer, and a thermocouple, and were dissolved at 170° C.

| | |
|---|---|
| Bisphenol A propylene oxide 2 mol adduct | 285.7 parts by mass |
| Terephthalic acid | 66.9 parts by mass |
| Fumaric acid | 47.4 parts by mass |

In the next step, the following raw material monomers for an addition-polymerized resin (styrene-acrylic resin: StAc) unit and the following radical polymerization initiator in the dropping funnel were added dropwise over 90 minutes. The solution was aged for 60 minutes, and the non-reacted monomers were removed under reduced pressure (8 kPa).

An esterification catalyst Ti (OBu)₄ (0.4 parts by mass) was then added to the reaction system. The reaction system was heated to 235° C. to promote a reaction under normal pressure (101.3 kPa) for five hours, and then under reduced pressure (8 kPa) for one hour.

After the reaction system was cooled to 200° C., the reaction was continued under reduced pressure (20 kPa) until a desired softening point was attained. The solvent was then removed to prepare Resin for a shell [s1] as an amorphous resin. Resin for a shell [s1] had a glass transition temperature (Tg) of 60° C. and a weight average molecular weight (Mw) of 30000.

Resin for a shell [s1] (100 parts by mass) was dissolved in ethyl acetate (made by KANTO CHEMICAL CO., INC.) (400 parts by mass), and was mixed with a solution (638 parts by mass) of 0.26 mass % sodium lauryl sulfate preliminarily prepared. The mixed solution was ultrasonically dispersed with an ultrasonic homogenizer “US-150T” (made by NIHONSEIKI KAISHA LTD.) at a V-LEVEL of 300 μA for 30 minutes with stirring. While the solution was kept at 40° C., ethyl acetate was completely removed with a diaphragm vacuum pump “V-700” (made by BUCHI Labortechnik AG) with stirring under reduced pressure for three hours. Aqueous dispersion [S1] of amorphous resin nanoparticles (solid content: 13.5 mass %) was thereby prepared. The amorphous resin nanoparticles in Aqueous dispersion [S1] had a volume median particle size of 160 nm.

### <Preparation of Toner [1] and Developer [1]>

Aqueous dispersion [M1] of Resin nanoparticles [m1] (200 parts by mass in terms of the solid content) and deionized water (2000 parts by mass) were placed in a reaction container provided with a stirrer, a temperature sensor, and a cooling tube. An aqueous solution of 5 mol/L sodium hydroxide was added to adjust the pH to 10.

Aqueous colorant nanoparticle dispersion [Bk] (40 parts by mass in terms of the solid content) was added, and an aqueous solution of magnesium chloride (60 parts by mass) in deionized water (60 parts by mass) was added with stirring at 30° C. over 10 minutes. Heating of the system was started. The system was heated to 70° C. over 50 minutes, and Aqueous dispersion [C1] (25 parts by mass in terms of the solid content) of Resin nanoparticles [c1] was added over 10 minutes. The system was then heated to 83° C. over 20 minutes. The particle sizes of associated particles in this state were determined with a particle size analyzer “Coulter Multisizer 3” (made by Beckman Coulter, Inc.). When the volume median particle size reached 6.0 μm, Aqueous dispersion [S1] of amorphous resin nanoparticles (20 parts by mass in terms of the solid content) was added over 60 minutes. An aqueous solution of sodium chloride (190 parts by mass) in deionized water (760 parts by mass) was added to stop growth of the particles. The system was further heated at 80° C. with stirring to promote fusion of the particles. In this fusing step, the aspect ratios of the domains of the mold release agent and the domains of the plasticizer in the particulate toner were controlled through control of the amounts of the raw materials for the mold release agent, the plasticizer, and the binder resin to be added, the reaction time (stirring time), and the heating temperature. The system was further heated, and was stirred under heating at 80° C. to progress fusing of the particles. When the average circularity of the toner determined with FPIA-2100 (made by Sysmex Corporation) (4000 particles detected in a high-power field (HPF)) was 0.945, the system was cooled to 30° C. at a cooling rate of 2.5° C./min.

Solid liquid separation was then performed, and the dehydrated toner cake was redispersed in deionized water. This operation of solid liquid separation was repeated three times. The product was dried at 40° C. for 24 hours to prepare Black toner particles [1X].

Hydrophobic silica (number average primary particle diameter=12 nm, degree of hydrophobization=68) (0.6 parts by mass) and hydrophobic titanium oxide (number average primary particle diameter=20 nm, degree of hydrophobization=63) (1.0 part by mass) were added to the toner particles [1X] (100 parts by mass), and were mixed with a Henschel mixer (made by) at a circumferential velocity of a rotary blade of 35 mm/sec and 32° C. for 20 minutes. Coarse particles were removed with a sieve having an opening of 45 μm. External additives were thereby applied to the toner particles to prepare Toner [1].

A ferrite carrier having a volume average particle size of 60 μm and coated with a silicone resin was mixed with Toner [1] such that the content of the toner was 6 mass %. Developer [1] was thereby prepared.

### <Preparation of Toners [2] to [14] and Developers [2] to [14]>

Toners [2] to [14] and Developers [2] to [14] were prepared as in preparation of Toner [1] and Developer [1] except that the types and the amounts of Aqueous dispersion [M1] of Resin nanoparticles [m1] containing mold release agent, Aqueous dispersion [C1] of Resin nanoparticles [c1] containing plasticizer, and Aqueous dispersion [S1] of amorphous resin nanoparticles were varied as shown in Table 2.

TABLE 2

| | Aqueous dispersion | | Aqueous dispersion | | | |
|---|---|---|---|---|---|---|
| | of resin | | of resin | | Aqueous dispersion | |
| | nanoparticles | | nanoparticles | | S1 of amorphous | |
| | containing mold | | containing | | resin | |
| | release agent | | plasticizer | | nanoparticles | |
| Toner No. | | [Parts by mass | | [Parts by mass | [Parts by mass | |
| (Developer | | (in terms of | | (in terms of | (in terms of | |
| No.) | No. | solid content)] | No. | solid content)] | solid content)] | Notes |
| 1 | M1 | 200 | C1 | 25 | 20 | Example |
| 2 | M2 | 201 | C1 | 41 | 32 | Example |
| 3 | M3 | 202 | C1 | 13 | 40 | Example |
| 4 | M4 | 203 | C2 | 17 | 20 | Example |
| 5 | M4 | 200 | C2 | 25 | 45 | Example |
| 6 | M4 | 205 | C2 | 25 | 20 | Example |
| 7 | M5 | 130 | C3 | 30 | 130 | Example |
| 8 | M6 | 35 | C3 | 10 | 50 | Example |
| 9 | M7 | 55 | C3 | 19 | 20 | Example |
| 10 | M3 | 202 | C1 | 13 | 0 | Example |
| 11 | M4 | 105 | C1 | 43 | 40 | Comparison |
| 12 | M3 | 202 | C1 | 78 | 30 | Comparison |
| 13 | M6 | 36 | C4 | 71 | 130 | Comparison |
| 14 | M7 | 105 | C1 | 16 | 40 | Comparison |

### <<Calculation of Average Aspect Ratios of Domains of Mold Release Agent and Domains of Plasticizer>>

### <Preparation of Sections of Particulate Toners>

The toners (1 to 2 mg) prepared through the process described above were each placed in a 10 mL sample bottle such that toner particles were spread, and were stained with vapor of ruthenium tetraoxide (RuO₄) under the following conditions. The stained toners were each dispersed in a photocurable resin “D-800” (made by JEOL, Ltd.), and were cured with UV light to form blocks. The blocks were sliced with a microtome having a diamond knife to prepare ultra-thin samples having a thickness of 60 to 100 nm.

<Conditions on Staining with Ruthenium Tetraoxide>

The toners were stained with a vacuum electron staining apparatus VSC1R1 (made by Filgen, Inc.). A sublimation chamber containing ruthenium tetraoxide was installed in the body of the staining apparatus according to the procedure of the apparatus. Each ultra-thin sample was introduced into a staining chamber, and was stained with ruthenium tetraoxide at room temperature (24 to 25° C.) and Concentration level 3 (300 Pa) for 10 minutes.

### <Observation of Cross Sections of Domains of Mold Release Agent and Domains of Plasticizer in Toner Particles>

The domains of the mold release agent and the domains of the plasticizer in the cross sections of the toner particles stained on the above conditions were observed within 24 hours from the staining step under the following conditions:

Apparatus: transmission electron microscope “JEM-2000FX” (made by JEOL, Ltd.)

Sample: section of the particulate toner stained with ruthenium tetraoxide (RuO₄) (thickness of the section: 60 to 100 nm)

Accelerating voltage: 80 kV

Magnification: ×50000, bright-field image

### <Calculation of Average Aspect Ratios of Domains of Mold Release Agent and Domains of Plasticizer>

The images photographed with the transmission electron microscope were each analyzed with an image processing analyzer “LUZEX AP” (made by NIRECO CORPORATION) to determine the long axis lengths and the short axis lengths of the domains of the mold release agent and the domains of the plasticizer in the particulate toners. In these images, the whitest portions were defined as the domains of the mold release agent, and whiter portions as the domains of the plasticizer. The long axis length of each domain was divided by the short axis length thereof to calculate the aspect ratio of the domain. Toner particles were selected at random, and 100 domains present in any cross section of each toner particle were selected. The aspect ratios of these 100 domains were determined, and the average thereof was calculated as the average aspect ratio of the domains.

### <<Evaluation>>

Toners 1 to 14 and Developers 1 to 14 were evaluated according to the following procedures to rank the toners.

### <Low-Temperature Fixing Characteristics>

The developers prepared as described above were each loaded into a copier “bizhub PRO C6501” (made by KONICA MINOLTA, INC.) including a fixing unit modified such that the surface temperature of the heat roller for fixing was varied in the range of 100 to 210° C. In the fixing test, a solid image with a toner density of 11 mg/10 cm² was repeatedly fixed on a size A4 plain paper sheet (basis weight: 80 g/m²) while the fixing temperature was being stepwise varied for every sheet from 85° C. to 130° C. in an increment of 5° C.

In the next step, the print products obtained at these fixing temperatures in the fixing test were folded with a paper folder such that a load was applied to the solid image. Compressed air of 0.35 MPa was sprayed onto the folds of the print products. The folds were evaluated according to the following criteria, Ranks 1 to 5. Evaluation of the toner was performed on the print product obtained at the lower limit fixing temperature, which was defined as the lowest fixing temperature among the fixing temperatures of the print products evaluated as Rank 3 in the fixing test.

As the lower limit fixing temperature is lower, low-temperature fixing characteristics are superior. The lower limit fixing temperature of 120° C. or less was determined as acceptable “◯” without problems in practical use.

### (Criteria on Evaluation of Folds)

Rank 5: No peel of the toner in the fold. Rank 4: Partial peel of the toner along the fold. Rank 3: Peel of the toner in the form of fine lines along the fold.

Rank 2: Peel of the toner in the form of thick lines along the fold.

Rank 1: Noticeable peel of the toner.

### <Heat Resistance>

A toner (0.5 g) was placed in a 10 mL glass bottle having an inner diameter of 21 mm. The bottle was sealed with the lid, and was shaken 600 times at room temperature with a Tap Denser KYT-2000 (made by Seishin Enterprise Co., Ltd.). The lid was removed, and the bottle was left under an environment at 55° C. and 35% RH for two hours. In the next step, the toner was carefully placed on a 48-mesh sieve (opening: 350 μm) so as not to disintegrate aggregates of the toner. The sieve was set on a powder tester (made by Hosokawa Micron Corporation), and was fixed with a presser bar and a knob nut. The intensity of vibration was adjusted at a vibration width of 1 mm to vibrate the sieve for 10 seconds. The proportion (mass %) of the amount of the residual toner on the sieve was determined.

The toner aggregation rate is calculated from the following expression:

(Toner aggregation rate (%))=((mass of residual toner on sieve (g))/0.5 (g))×100

Ranks “⊚” and “◯” were determined as acceptable according to the following criterion:

### (Criteria)

⊚: A toner aggregation rate of less than 15 mass % (toner has significantly high heat-resistant storage characteristics)

◯: A toner aggregation rate of 15 mass % or more and 20 mass % or less (toner has high heat-resistant storage characteristics)

×: A toner aggregation rate of more than 20% (toner has poor heat-resistant storage characteristics, and cannot be used)

### <Post-Fixing Separability>

The developers prepared above were each loaded into the developing unit of a multifunctional full-color machine “bizhub PRO C6501” (made by KONICAMINOLTA, INC.), and were sequentially evaluated. The multifunctional full-color machine was modified such that the fixing temperature, the amount of the toner to be applied, and the speed of the system were freely varied. The paper used in evaluation was OK Topcoat+ 85 g/m² (made by Oji Paper Co., Ltd.). The temperature of the upper fixing belt was set at a temperature 25° C. higher than the under-offset-free temperature ((under-offset-free temperature) +25° C.), where the under-offset-free temperature was defined as the temperature at which no under-offset occurred. The temperature of the lower fixing roller was set at 90° C. A solid image (toner density: 8.0 g/m²) was output while the top margin was being varied. The top margin of the output immediately before a paper jam occurred was used as a scale of post-fixing separability. A smaller separable top margin indicates higher separability. The solidi image was output under an environment at normal temperature and normal humidity (NN environment: 25° C., 50% RH). Ranks “⊚” to “Δ” were determined as acceptable according to the following criteria:

### (Criteria)

⊚: A separable top margin of less than 2 mm

◯: A separable top margin of 2 mm or more and less than 5 mm

Δ: A separable top margin of 5 mm or more and less than 10 mm

×: A separable top margin of 10 mm or more

### <Durability>

The durability of the toner was evaluated by scattering of the toner. The developers prepared described above were each loaded into the developing unit of a multifunctional full-color machine “bizhub PRO C6501” (made by KONICA MINOLTA, INC.), and were sequentially evaluated. Printing was performed on 500000 sheets. Scattering of the toner was evaluated according to the contamination of hands of a user after replacement of the developing unit. Ranks “⊚” to “Δ” were determined as acceptable according to the following criteria:

### (Criteria)

⊚: No scattering of the toner. No contamination of the hands of the user after replacement of the developing unit.

◯: Scattering of the toner onto the upper lid near the developing roller.

Δ: Scattering of the toner onto part of the lid above the developing unit.

×: Significant scattering of the toner such that the user should wash hands after replacement of the developing unit.

The values obtained from the measurements and the results are shown in Table 3.

“Content of mold release agent” and “Content of plasticizer”, respectively, represent the proportion (mass %) of the mold release agent and the proportion (mass %) of the plasticizer relative to the total amount of the particulate toner excluding the nanoparticulate colorant. “Content of styrene-acrylic resin in binder resin” represents the proportion (mass %) of the amount of the styrene-acrylic resin unit relative to the total amount of the styrene-acrylic resin unit and the amorphous resin (amorphous polyester resin) in the particulate toner.

TABLE 3

| | | | | | Binder | | | Evaluation | | | | | |
|---|---|---|---|---|---|---|---|---|---|---|---|---|---|
| Toner No. | Mold release agent | | Plasticizer | | resin | Average | | | | Heat | | | |
| (Developer | | Content | *1 | Content | *2 | aspect ratio | | *5 | | resis- | | Dura- | |
| No.) | Type | [Mass %] | [Mass %] | [Mass %] | [Mass %] | *3 | *4 | *6 | Results | tance | *7 | bility | Notes |
| 1 | Microcryatalline wax | 8 | 10 | 10 | 90 | 3.9 | 2.5 | 105 | ◯ | ◯ | ◯ | ◯ | Example |
| 2 | Microcrystalline wax | 13 | 10 | 15 | 84 | 4.3 | 2.7 | 110 | ◯ | ◯ | ◯ | ◯ | Example |
| 3 | Microcrystalline wax | 5 | 10 | 5 | 83 | 3.3 | 2.3 | 100 | ◯ | ◯ | ◯ | ◯ | Example |
| 4 | Microcrystalline wax | 9 | 20 | 7 | 90 | 2.8 | 1.1 | 100 | ◯ | ◯ | ⊚ | ◯ | Example |
| 5 | Microcrystalline wax | 8 | 20 | 9 | 80 | 3.0 | 1.2 | 110 | ◯ | ◯ | ⊚ | ◯ | Example |
| 6 | Microcrystalline wax | 9 | 20 | 10 | 90 | 3.1 | 1.2 | 105 | ◯ | ◯ | ⊚ | Δ | Example |
| 7 | Microcrystalline wax | 7 | 0 | 10 | 46 | 4.6 | 2.8 | 105 | ◯ | ◯ | ◯ | ◯ | Example |
| 8 | Microcrystalline wax | 5 | 0 | 11 | 38 | 5.2 | 2.7 | 115 | ◯ | ◯ | Δ | ◯ | Example |
| 9 | Microcrystalline wax | 6 | 0 | 20 | 71 | 5.4 | 2.9 | 100 | ◯ | ◯ | Δ | ⊚ | Example |
| 10 | Microcrystalline wax | 6 | 10 | 6 | 100 | 3.8 | 1.8 | 110 | ◯ | ⊚ | ◯ | ◯ | Example |
| 11 | Behenyl behenate | 6 | 10 | 23 | 70 | 1.4 | 2.1 | 105 | ◯ | X | Δ | X | Comparison |
| 12 | Microcrystalline wax | 4 | 0 | 25 | 86 | 1.7 | 3.2 | 130 | X | ◯ | X | ◯ | Comparison |
| 13 | Microcrystalline wax | 1 | 5 | 30 | 20 | 1.6 | 3.1 | 110 | ◯ | X | X | Δ | Comparison |
| 14 | Behenyl behenate | 7 | 10 | 10 | 70 | 1.2 | 2.3 | 110 | ◯ | X | ◯ | X | Comparison |

*1: the content of the styrene-acrylic resin unit in the resin nanoparticles
*2: the content of the styrene-acrylic resin unit in the binder resin
*3: Average Aspect ratio of mold release agent Aw
*4: Average aspect ratio of plasticizer Ac
*5: Low-temperature fixing characteristics
*6: Lower limit fixing temperature [° C.]
*7: Post-fixing separability

The results in Table 3 evidently show that Toners 1 to 10 according to the present invention had significantly higher low-temperature fixing characteristics, heat-resistant storage characteristics, post-fixing separability, and durability than those of Toners 11 to 14 of Comparative Examples. In contrast, Toners 11 to 14 of Comparative Examples were inferior in one of these characteristics.

This U.S. patent application claims priority to Japanese patent application No. 2015-087222 filed on Apr. 22, 2015, the entire contents of which are incorporated by reference herein for correction of incorrect translation.

What is claimed is:

1. A particulate toner for developing electrostatically charged image, comprising:
a binder resin,
a colorant,
a mold release agent, and
a plasticizer,
wherein the binder resin comprises a styrene-acrylic resin, and
a relationship represented by Expression (1) is satisfied:
Ac<Aw (1)
where Aw represents an average aspect ratio of domains of the mold release agent, and Ac represents an average aspect ratio of domains of the plasticizer in a cross section of the particulate toner.

2. The toner for developing electrostatically charged image according to claim 1,
wherein the binder resin comprises 30 mass % or more styrene-acrylic resin.

3. The toner for developing electrostatically charged image according to claim 1,
wherein relationships represented by Expressions (2) and (3) are satisfied:
1.5≦Aw≦6.0 (2)
1.0≦Ac≦3.0 (3)
where Aw represents the average aspect ratio of the domains of the mold release agent, and Ac represents the average aspect ratio of the domains of the plasticizer in the cross section of the particulate toner.

4. The toner for developing electrostatically charged image according to claim 1,
where the mold release agent comprises a microcrystalline wax.

5. The toner for developing electrostatically charged image according to claim 1,
wherein the plasticizer comprises a crystalline polyester resin.

6. The toner for developing electrostatically charged image according to claim 1,
wherein the plasticizer comprises a hybrid resin comprising a crystalline polyester resin unit and an amorphous resin unit bonded to each other.

7. The toner for developing electrostatically charged image according to claim 6,
wherein the amorphous resin unit comprises a styrene-acrylic resin unit, and
a content of the styrene-acrylic resin unit is 20 mass % or less of that of the hybrid resin.

8. The toner for developing electrostatically charged image according to claim 1,
wherein a content of the mold release agent and a content of the plasticizer are each within a range of 5 to 20 mass % of a total amount of the particulate toner excluding the colorant.

9. The toner for developing electrostatically charged image according to claim 1,
wherein the domains of the mold release agent and the domains of the plasticizer are independently present.
